(19) United States
(12) Patent Application Publication
(10) Pub. No.: US 2015/0062027 A1
(43) Pub. Date: Mar. 5, 2015

(54) ELECTRONIC DEVICE AND METHOD FOR CONTROLLING SCREEN

(71) Applicant: Samsung Electronics Co., Ltd., Gyeonggi-do (KR)

(72) Inventors: Chang-Mo Yang, Gyeonggi-do (KR); Chul-Ho Jang, Seoul (KR); Joong-Hun Kwon, Seoul (KR); Eun-Ju Kim, Seoul (KR); Jong-Sung Joo, Seoul (KR); Hui-Chul Yang, Gyeonggi-do (KR)

(21) Appl. No.: 14/295,890

(22) Filed: Jun. 4, 2014

(30) Foreign Application Priority Data
Aug. 29, 2013 (KR) 10-2013-0103479

(51) Int. Cl. G06F 3/01; G06F 3/041

(52) U.S. Cl. CPC G06F 3/017; G06F 3/0416; G06F 2203/04108
USPC 345/173

(57) ABSTRACT

A method for controlling a screen in an electronic device is provided. The method includes displaying a first page on a screen; detecting a gesture that is input to the screen; sliding out the first page displayed on the screen from the screen in response to the detection of the gesture; and sliding in a second page to the screen in response to the sliding out of the first page. In displaying the first page on the screen, the first page is displayed on the screen, covering a first region of the second page.

### PRIORITY

This application claims priority under 35 U.S.C. §119(a) to a Korean Patent Application filed in the Korean Intellectual Property Office on Aug. 29, 2013 and assigned Serial No. 10-2013-0103479, the entire disclosure of which is incorporated herein by reference.

### BACKGROUND

1. Field of the Invention

The present invention generally relates to an electronic device and method for controlling a screen.

2. Description of the Related Art

Recently, the number of services and additional features provided by electronic devices has gradually increased. In order to increase the utility of the electronic devices and satisfy various needs of users, a variety of applications which are executable in the electronic devices have been developed.

Accordingly, in recent years, a large number of applications may be stored in mobile electronic devices with a touch screen, such as smart phones, cellular phones, laptop Personal Computers (PCs), tablet PCs and the like. Objects (or shortcut icons) used for executing their associated applications may be displayed on the screen of the electronic devices. Accordingly, a user may execute his/her desired application in the electronic device by touching its associated shortcut icon displayed on the screen. On the screen of the electronic device may be displayed various types of visual objects such as widgets, photos, documents and the like, in addition to the shortcut icons.

As such, the electronic devices provide a touch input scheme in which the user may touch the displayed objects using a touch input unit such as the user's finger, an electronic pen, a stylus pen and the like. The touch input scheme may be classified into a direct touch input scheme in which a contact touch with the screen is made by the user's body or a touch input unit, and an indirect touch input scheme in which a noncontact touch with the screen is made by hovering. These touch input schemes provide convenient user interfaces.

In recent years, a screen-based input scheme, or a haptic input scheme, has been provided, which generates vibrations with a vibration device upon receiving a touch input, allowing the user to experience a manipulation feeling of pushing buttons. Studies of these various touch input technologies have been consistently made, and research has been conducted to meet the demands for fun and new sense interfaces desired by users. In addition, the screen of the electronic devices may move a page or display searched content in response to an input such as a swipe, which is a gesture of controlling display of a screen by horizontally or vertically moving a touch made on the screen by a predetermined distance while maintaining the touch, and a flick which is a gesture of controlling display of a screen by touching an input unit to the screen and then releasing the input unit from the screen after rapidly moving the input unit. Intuitive search methods based on these gestures are required.

As described above, conventionally, if a user inputs a gesture to manipulate a screen of an electronic device, the electronic device may simply slide a page in response to the input gesture, but may not display a page or content for the user in a faster and intuitive way. Therefore, there is a need for a way to determine whether a gesture of controlling a page is input to a touch screen and visually displays the input of a gesture for the user, thereby improving the user's convenience.

### SUMMARY

The present invention has been made to address at least the above-mentioned problems and/or disadvantages and to provide at least the advantages described below. Accordingly, an aspect of the present invention is to provide an electronic device and method for controlling a screen.

In accordance with an aspect of the present invention, there is provided a method for controlling a screen in an electronic device. The method includes displaying a first page on a screen; detecting a gesture that is input to the screen; sliding out the first page displayed on the screen from the screen in response to the detection of the gesture; and sliding in a second page to the screen in response to the sliding out of the first page. In the displaying of the first page on the screen, the first page may be displayed on the screen, covering a first region of the second page.

In accordance with another aspect of the present invention, there is provided an electronic device for controlling a screen. The electronic device includes a screen configured to display a first page; and a controller configured to slide out the first page displayed on the screen from the screen in response to a gesture that is input to the screen, and to slide in a second page to the screen in response to the sliding out of the first page. The first page may be displayed on the screen, covering a first region of the second page.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates an electronic device according to various embodiments of the present invention;

FIG. 2 illustrates an input unit and a configuration of a screen according to an embodiment of the present invention;

FIG. 3A illustrates the configuration of pages displayed on a screen of an electronic device according to an embodiment of the present invention;

FIG. 3B illustrates the configuration of pages displayed on a screen of an electronic device according to another embodiment of the present invention;

FIG. 4 is a flowchart illustrating a method for controlling a screen in an electronic device according to an embodiment of the present invention;

FIG. 5 is a flowchart illustrating a method for controlling a screen in an electronic device according to another embodiment of the present invention;

FIG. 6A illustrates a top view of a screen before a gesture is input thereto according to an embodiment of the present invention;

FIG. 6B illustrates a front view of a screen on which sliding of pages begins after the input of a gesture according to an embodiment of the present invention;

FIG. 6C illustrates a front view of a screen on which sliding of pages is performed after the input of a gesture according to an embodiment of the present invention;

FIG. 6D illustrates a front view of a screen on which sliding of pages is about to be completed after the input of a gesture according to an embodiment of the present invention;

FIG. 6E illustrates a front view of a screen on which sliding of pages is completed after the input of a gesture according to an embodiment of the present invention;

FIG. 7A illustrates an end view of a screen before a gesture is input thereto according to an embodiment of the present invention;

FIG. 7B illustrates an end view of a screen on which sliding of pages begins after the input of a gesture according to an embodiment of the present invention;

FIG. 7C illustrates an end view of a screen on which sliding of pages is performed after the input of a gesture according to an embodiment of the present invention;

FIG. 7D illustrates an end view of a screen on which sliding of pages is about to be completed after the input of a gesture according to an embodiment of the present invention;

FIG. 7E illustrates an end view of a screen on which sliding of pages is completed after the input of a gesture according to an embodiment of the present invention;

FIG. 8 is a flowchart illustrating a method for controlling a screen in an electronic device according to another embodiment of the present invention;

FIG. 9A illustrates a front view of a screen before a gesture is input thereto according to another embodiment of the present invention;

FIG. 9B illustrates a front view of a screen on which sliding of pages begins after the input of a gesture according to another embodiment of the present invention;

FIG. 9C illustrates a front view of a screen on which sliding of pages is performed after the input of a gesture according to another embodiment of the present invention;

FIG. 9D illustrates a front view of a screen on which sliding of pages is about to be completed after the input of a gesture according to another embodiment of the present invention;

FIG. 9E illustrates a front view of a screen on which sliding of pages is completed after the input of a gesture according to another embodiment of the present invention;

FIG. 10A illustrates an end view of a screen before a gesture is input thereto according to another embodiment of the present invention;

FIG. 10B illustrates an end view of a screen on which sliding of pages begins after the input of a gesture according to another embodiment of the present invention;

FIG. 10C illustrates an end view of a screen on which sliding of pages is performed after the input of a gesture according to another embodiment of the present invention;

FIG. 10D illustrates an end view of a screen on which sliding of pages is about to be completed after the input of a gesture according to another embodiment of the present invention;

FIG. 10E illustrates an end view of a screen on which sliding of pages is completed after the input of a gesture according to another embodiment of the present invention;

FIG. 11A illustrates a front view of a screen before a gesture is input thereto according to another embodiment of the present invention;

FIG. 11B illustrates a front view of a screen on which sliding of pages begins after the input of a gesture according to another embodiment of the present invention;

FIG. 11C illustrates a front view of a screen on which sliding of pages is performed after the input of a gesture according to another embodiment of the present invention;

FIG. 11D illustrates a front view of a screen on which sliding of pages is about to be completed after the input of a gesture according to another embodiment of the present invention;

FIG. 11E illustrates a front view of a screen on which sliding of pages is completed after the input of a gesture according to another embodiment of the present invention;

FIG. 12A illustrates a front view of a screen before a gesture is input thereto according to another embodiment of the present invention;

FIG. 12B illustrates a front view of a screen on which sliding of pages begins after the input of a gesture according to another embodiment of the present invention;

FIG. 12C illustrates a front view of a screen on which sliding of pages is performed after the input of a gesture according to another embodiment of the present invention;

FIG. 12D illustrates a front view of a screen on which sliding of pages is about to be completed after the input of a gesture according to another embodiment of the present invention;

FIG. 12E illustrates a front view of a screen on which sliding of pages is completed after the input of a gesture according to another embodiment of the present invention;

FIG. 13A illustrates a screen on which a page is slid out in response to an input of a gesture according to an embodiment of the present invention;

FIG. 13B illustrates a screen on which a page drops by being slid out in response to an input of a gesture according to another embodiment of the present invention;

FIG. 14A illustrates a screen on which an upper page is slid out in response to a gesture according to an embodiment of the present invention;

FIG. 14B illustrates a screen on which a lower page is slid in, in response to a gesture according to an embodiment of the present invention; and

FIG. 14C illustrates a screen on which at least two layers constituting a lower page are slid in at different speeds in response to a gesture according to an embodiment of the present invention.

Throughout the drawings, like reference numerals will be understood to refer to like parts, components, and structures.

### DETAILED DESCRIPTION OF EMBODIMENTS OF THE PRESENT INVENTION

The following description with reference to the accompanying drawings is provided to assist in a comprehensive understanding of embodiments of the present invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

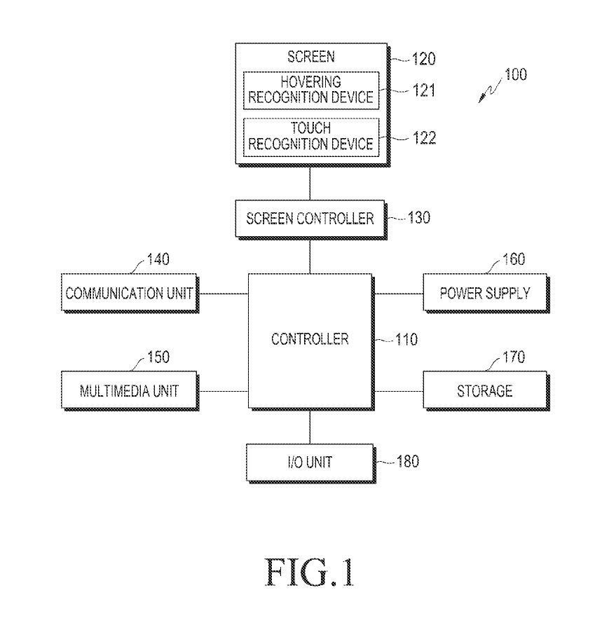

FIG. 1 illustrates an electronic device according to various embodiments of the present invention.

Referring to FIG. 1, an electronic device 100 may be connected to external devices using at least one of a communication unit 140, a connector and an earphone jack. The external devices include various devices such as earphones, external speakers, Universal Serial Bus (USB) memories, chargers, cradles/docks, Digital Multimedia Broadcasting (DMB) antennas, mobile payment devices, healthcare devices (e.g., blood glucose meters and the like), game consoles, car navigation devices and the like, each of which can be detachably connected to the electronic device 100 by wires. The external devices may also include Bluetooth devices, Near Field Communication (NFC) devices, WiFi Direct devices, and wireless Access Points (APs), each of which can be wirelessly connected to the electronic device 100. The electronic device 100 may be connected by wires or wirelessly to other devices (e.g., mobile terminals, smart phones, tablet PCs, desktop PCs, digitizers, input devices, cameras, servers and the like).

The electronic device 100 includes at least one screen 120, at least one screen controller 130, the communication unit 140, a multimedia unit 150, a power supply 160, a storage 170, and an Input/Output (I/O) unit 180.

The electronic device of the present invention is a mobile terminal capable of data transmission/reception and voice/video calls, and may have at least one screen, and each screen may display at least one page. This electronic device may include a smart phone, a tablet PC, a Three-Dimensional (3D) Television (TV), a smart TV, a Light Emitting Diode (LED) TV, a Liquid Crystal Display (LCD) TV, a tablet PC, and the like. In addition, the electronic device may include any devices capable of communicating with peripheral devices or other terminals located in remote places. At least one screen mounted on the electronic device may receive an input that is made by at least one of a touch and hovering.

The electronic device 100 includes at least one screen 120 that provides user interfaces corresponding to various services (e.g., call services, data transmission services, broadcasting services, photo-shooting services, string input services and the like), to the user. Each screen may include a hovering recognition device 121 for recognizing a hovering input made by at least one of an input unit and a finger, and a touch recognition device 122 for recognizing a touch input made by at least one of an input unit and a finger. The hovering recognition device 121 and the touch recognition device 122 may be referred to as a hovering recognition panel and a touch recognition panel, respectively. Each screen may transfer, to its associated screen controller, an analog signal corresponding to at least one touch or at least one hovering, which is input to a user interface. As such, the electronic device 100 may have a plurality of screens, and each screen may have its own screen controller that receives an analog signal corresponding to a touch or hovering. Each screen may be hinge-connected to each of a plurality of housings, or a plurality of screens may be mounted on a single housing without a hinge connection. In various embodiments of the present invention, the electronic device 100 may have a plurality of screens, as described above. However, for convenience of description, the electronic device 100 will be assumed herein to have one screen.

An input unit according to various embodiments of the present invention may include at least one of a finger, an electronic pen, a digital type pen, a pen without an Integrated Circuit (IC), a pen equipped with an IC, a pen equipped with an IC and a memory, a pen capable of short-range communication, a pen equipped with an additional ultrasonic detector, a pen equipped with an optical sensor, a joystick, and a stylus pen, each of which can provide a command or an input to the electronic device if the input unit makes contact touch or noncontact touch (e.g., hovering) on a digitizer of the screen.

A controller 110 may include a Central Processing Unit (CPU), a Read Only Memory (ROM) that stores a control program for control of the electronic device 100, and a Random Access Memory (RAM) that temporarily stores signals or data received from the outside of the electronic device 100, and/or is used as a workplace for operations performed in the electronic device 100. The CPU may include a single-core processor, a dual-core processor, triple-core processor, or a quad-core processor.

The controller 110 controls at least one of the screen 120, the hovering recognition device 121, the touch recognition device 122, the screen controller 130, the communication unit 140, the multimedia unit 150, the power supply 160, the storage 170, and the I/O unit 180.

The controller 110 determines whether hovering is recognized, which occurs as one of various input units approaches any one object while various objects or input strings are displayed on the screen 120, and identifies an object corresponding to a position where the hovering has occurred. The controller 110 detects a height from the electronic device 100 (to be specific, the screen 120) to the touch input unit, and may also detect a hovering input event corresponding to the height. The hovering input event may include at least one of an event that a button formed on the touch input unit is pressed, an event that the input unit is tapped, an event that the touch input unit moves faster than a predetermined speed, and an event that the touch input unit keeps in touch with an object.

The controller 110 according to an embodiment of the present invention detects a gesture that is input to the screen 120, adjusts the sliding speed of at least one page that is displayed on the screen 120 that slides in a direction of the detected gesture, and displays at least one page at the adjusted speed. The controller 110 may adjust or determine the sliding speed of a slide-out page to be higher than the sliding speed of a slide-in page in response to a gesture input. On the contrary, the controller 110 may adjust or determine the sliding speed of a slide-out page to be lower than the sliding speed of a slide-in page in response to a gesture input. The controller 110 may adjust the sliding speed of at least one page to be different from other pages. Each of at least one page may be comprised of at least one layer, and each layer may be displayed such that the sliding speed thereof is adjusted by an input gesture to be different from other pages. If at least two layers are configured in each of at least one page, the controller 110 may cause the top layer among the at least two layers to have the highest sliding speed, and cause the lower layers to have lower sliding speeds. On the contrary, the controller 110 may cause the top layer to have the lowest sliding speed, and cause the lower layers to have higher sliding speeds. The controller 110 may provide visual effects to a slide-out page being displayed, in response to an input gesture, and the visual effects may include at least one of shadow effects which are applied to at least one edge of the slide-out page, and 3D effects of the slide-out page. In addition to these effects, the present invention may include a variety of effects allowing the user to recognize that visual effects are provided to the page. The controller 110 may output sounds corresponding to the display of at least one page, through the I/O unit 180. The sounds may be the same as or different from each other in response to at least one of a gesture speed, a gesture direction, attributes of a slide-out page, attributes of a slide-in page, the number of sliding pages, and visual effects.

While a first page is displayed on the screen 120, the controller 110 may slide out the first page displayed on the screen 120 from the screen 120 in response to a gesture that is input to the screen 120, and slide in a second page to the screen 120 in response to the sliding out of the first page. In this case, the first page displayed on the screen 120 may be displayed on the screen 120 to cover a first region of the second page. The controller 110 may display the first region of the second page, which was covered by the first page, on the screen 120 as it slides, and display a second region of the second page except for the first region in a sliding-in manner. Upon detecting a gesture for displaying again the first page on the screen 120, the controller 110 may slide out the second page displayed on the screen 120 from the screen 120 in response to the detection of the gesture, and slide in the first page to the screen 120 in response to the sliding out of the second page. In this case, the second page may be displayed on the screen 120, covering a second region of the first page. The controller 110 may display the second region of the first page, which was covered by the second page, on the screen 120 in a sliding manner, and display a first region of the first page except for the second region as it slides.

The controller 110 according to another embodiment of the present disclosure detects a gesture that is input to the screen 120, applies different sliding speeds of a slide-out page and a slide-in page in response to the input gesture, and provides visual effects to the slide-out page being displayed, in response to the sliding of the slide-out page. The controller 110 may apply the sliding speed of the slide-out page to be higher than the sliding speed of the slide-in page, or apply the sliding speed of the slide-out page to be lower than the sliding speed of the slide-in page. The controller 110 may measure the speed of the gesture that is applied to the screen 120, and compare the measured speed with a speed in a predetermined threshold range. If at least two gestures which are input to the screen 120 are detected, the controller 110 may measure the speed of each of the gestures. The controller 110 may determine a gesture corresponding to the highest speed by measuring the speed of each of the gestures, and display at least one of the slide-out page and the slide-in page on the screen 120 in response to at least one of the direction of the gestures and the highest speed. If at least two gestures are detected, the controller 110 may calculate an average speed of speeds of the at least two gestures, and display at least one of the slide-out page and the slide-in page on the screen 120 in the direction of the gesture having the highest speed among the at least two gestures using the calculated average speed.

The controller 110 may determine the sliding speed of the slide-out page in proportion to the measured speed of the gesture. The controller 110 may adjust the sliding speed so that the slide-out page may be slid at the measured speed of the gesture. For example, if the measured speed is higher than the predetermined threshold range, the controller 110 controls the screen 120 to adjust the number of sliding pages to be greater than the number of sliding pages corresponding to the predetermined threshold range. The controller 110 may determine the number of pages that are slid out from the screen 120, in response to the comparison results between the measured speed and the speed in the predetermined threshold range. The number of pages may be proportional, or inversely proportional to the measured speed of the gesture. At least one of the slide-out page and the slide-in page in the present invention may be comprised of at least two layers, and the controller 110 may differently adjust the sliding speed of each layer being displayed to be different from each other, in proportion to the speed of the detected gesture. The controller 110 may equally adjust the sliding speed of each layer being displayed to be the same as each other, in proportion to the speed of the detected gesture. The controller 110 may cause the top layer among the at least two layers to have the highest sliding speed, and cause the lower layers to have lower sliding speeds. On the contrary, the controller 110 may cause the top layer among the at least two layers to have the lowest sliding speed, and cause the lower layers to have higher sliding speeds.

The controller 110 may output at least one of sounds and vibrations corresponding to the visual effects. At least one of the sounds and vibrations may be the same as or different from each other in response to at least one of a gesture speed, a gesture direction, attributes of a slide-out page, attributes of a slide-in page, the number of sliding pages, and visual effects. The controller 110 may apply visual effects to at least one of the slide-out page and slide-in page being displayed. The visual effects may include at least one of shadow effects which are applied to at least one edge of the slide-out page, and 3D effects of the slide-out page. The controller 110 may apply the shadow effects to the edge that is last displayed on the screen 120, among the edges of the slide-out page. The shadow effects may include visual effects which are provided to allow the user to recognize a shadow that is naturally formed by light. At least one of a length and a width of the shadow may be adjusted by at least one of the direction of the gesture and the speed of the gesture. The controller 110 may apply the 3D effects to the slide-out page in the process where the slide-out page disappears from the screen 120 as it slides. The 3D effects may include visual effects which are provided to allow the user to recognize that the slide-out page appears to move three-dimensionally. The 3D effects may include at least one of 3D effects that makes it appear that the slide-out page falls from the screen 120 as it slides, 3D effects that makes it appear that the slide-out page rises from the screen 120 as it slides, and 3D effects that makes it appear that the slide-out page disappears from the screen 120 as it rotates. At least one of these 3D effects may be effects that the user can recognize, and in addition to the 3D effects, the present invention may include a variety of visual effects allowing the user to recognize that the slide-out page appears to move three-dimensionally.

The controller 110 according to another embodiment of the present invention measures the speed of a gesture that is input to the screen 120, determines a sliding-out speed of a slide-out page and a sliding-in speed of a slide-in page in response to the measured speed, and performs sliding out and sliding in by applying visual effects to the slide-out page and the slide-in page being displayed, in response to the determined sliding-out speed and sliding-in speed, respectively. The controller 110 may measure the speed of a gesture that is input to the screen 120, and determine a sliding-out speed of at least one layer constituting the slide-out page and a sliding-in speed of at least one layer constituting the slide-in page, in response to the measured speed of the gesture. The controller 110 may adjust the sliding-out speed of the slide-out page to be higher than the sliding-in speed of the slide-in page. On the contrary, the controller 110 may adjust the sliding-out speed of the slide-out page to be lower than the sliding-in speed of the slide-in page.

At least one of the slide-out page and the slide-in page in the present invention may be comprised of at least two layers, and the controller 110 may apply the sliding speed of each layer being displayed to be different from each other, in proportion to the measured speed of the gesture. On the contrary, the controller 110 may apply the sliding speed of each layer being displayed to be different from each other, in inverse proportion to the measured speed of the gesture. For each page, the controller 110 may cause the top layer among the at least two layers to have the highest sliding speed, and cause the lower layers to have lower sliding speeds. On the contrary, the controller 110 may cause the top layer among the at least two layers to have the lowest sliding speed, and cause the lower layers to have higher sliding speeds.

Further, the slide-out page may be placed on the slide-in page. In this case, if a gesture is input, the controller 110 may adjust the ratio at which at least one of the slide-in page and slide-out page displayed on the screen 120 is displayed on the screen 120. The controller 110 may control the screen 120 to adjust the ratio at which the slide-in page is displayed on the screen 120 as it slides, to be higher than the ratio at which the slide-out page is slid out from the screen 120. On the contrary, the controller 110 may display the slide-out page on the screen 120 so that the ratio at which the slide-out page is displayed on the screen 120 may be lower than the ratio at which the slide-in page is displayed on the screen 120 as it slides. Pages including the slide-out page and the slide-in page may be classified by category, and each of the pages classified by category may constitute at least one page.

The controller 110 may output at least one of sounds and vibrations corresponding to the visual effects. At least one of the sounds and vibrations may be the same as or different from each other in response to at least one of a gesture speed, a gesture direction, attributes of a slide-out page, attributes of a slide-in page, the number of sliding pages, and visual effects. The visual effects may include at least one of shadow effects which are applied to at least one edge of the slide-out page, and 3D effects of the slide-out page. The 3D effects may include at least one of 3D effects that makes it appear that the slide-out page falls from the screen 120 as it slides, 3D effects that makes it appear that the slide-out page rises from the screen 120 as it slides, and 3D effects that makes it appear that the slide-out page disappears from the screen 120 as it rotates. The 3D effects may also include at least one of 3D effects that makes it appear that the slide-out page rises from the screen 120 in the middle of falling from the screen 120 as it slides, 3D effects that makes it appear that the slide-out page falls from the screen 120 in the middle of rising from the screen 120 as it slides, 3D effects that makes it appear that the slide-out page disappears from the screen 120 as it rotates, and 3D effects that makes it appear that the slide-out page gradually disappears from the screen 120 by a fading technique. At least one of these 3D effects may be effects that the user can recognize, and in addition to the 3D effects, the present invention may include a variety of visual effects allowing the user to recognize that the slide-out page appears to move three-dimensionally. The shadow effects may be applied differently depending on at least one of the measured speed of the gesture and the angle at which the slide-out page falls from the screen 120 as it slides. The controller 110 may detect at least one gesture that is made using at least one of a touch and hovering which are input to the screen 120. The gesture may include at least one of a swipe which is a gesture of moving a touch made on the screen 120 by a predetermined distance while maintaining the touch, a flick which is a gesture of making a touch on the screen 120 and then releasing the touch from the screen 120 after rapidly moving the touch, a hovering-based swipe on the screen 120, and a hovering-based flick on the screen 120.

The controller 110 according to another embodiment of the present invention adjusts a sliding speed of at least one page that is displayed on the screen 120 as it slides in the direction of a gesture that is input to the screen 120, and displays the at least one page on the screen 120 at the adjusted speed. The controller 110 may determine the direction of the gesture that is input to the screen 120. The controller 110 may determine the direction of a gesture by detecting at least one of a swipe gesture of moving a touch made on the screen 120 by a predetermined distance while maintaining the touch, a flick gesture of making a touch on the screen 120 and then releasing the touch from the screen 120 after rapidly moving the touch, a hovering-based swipe gesture on the screen 120, and a hovering-based flick gesture on the screen 120. The controller 110 may determine the direction of a flick or swipe gesture that is input to the screen 120, by determining a touch start point (where the touch gesture is first made on the screen 120) and a touch end point (wherein the touch gesture is ended). If a hovering gesture is input, the controller 110 may determine the direction of the hovering gesture by determining a hovering start point (where the hovering gesture is first detected) and a hovering end point (where the hovering gesture is ended). The controller 110 may adjust the sliding speed of at least one page to be different from other pages. The controller 110 may adjust or determine the sliding speed of a slide-out page to be higher than the sliding speed of a slide-in page in response to the gesture input. On the contrary, the controller 110 may adjust or determine the sliding speed of a slide-out page to be lower than the sliding speed of a slide-in page in response to the gesture input.

The controller 110 may adjust the sliding speed of at least one layer constituting each page of the at least one page. The controller 110 may measure the speed of a detected gesture, and compare the measured speed with a speed in a predetermined threshold range to adjust the sliding speed of the at least one page. Each page of the at least one page according to various embodiments of the present invention may be comprised of at least one layer, and each layer may be displayed such that the sliding speed thereof is adjusted by an input gesture to be different from other layers. If at least two layers are configured in each page of the at least one page, the controller 110 may cause the top layer among the layers to have the highest sliding speed, and cause the lower layers to have lower sliding speeds. On the contrary, the controller 110 may cause the top layer to have the lowest sliding speed, and cause the lower layers to have higher sliding speeds.

The controller 110 may apply visual effects to at least one page being displayed. The controller 110 may provide visual effects to a slide-out page being displayed, in response to an input gesture. The visual effects may include at least one of shadow effects which are applied to at least one edge of the slide-out page, and 3D effects of the slide-out page. In addition to these effects, the present invention may include a variety of effects allowing the user to recognize that visual effects are provided to the page. The controller 110 may output sounds corresponding to the visual effects, through the I/O unit 180. The sounds may be the same as or different from each other in response to at least one of a gesture speed, a gesture direction, attributes of a slide-out page, attributes of a slide-in page, the number of sliding pages, and visual effects.

If at least two gestures which are input to the screen 120 are detected, the controller 110 may adjust the sliding speed of at least one page by measuring the speed of each of the detected at least two gestures. If at least two gestures which are input to the screen 120 are detected, the controller 110 may measure the speed of each of the gestures. The controller 110 may adjust the sliding speed of the at least one page in response to the gesture corresponding to the highest speed among the measured speeds of the at least two gestures. The controller 110 may determine the gesture corresponding to the highest speed by measuring the speed of each gesture, and display at least one of a slide-out page and a slide-in page on the screen 120 in response to at least one of the direction of the gesture and the highest speed. The controller 110 may calculate an average speed of the measured speeds of the at least two gestures, and apply the calculated average speed to the gesture corresponding to the highest speed to adjust the sliding speed of the at least one page. If at least two gestures are detected, the controller 110 may calculate an average speed of speeds of the at least two gestures, and display at least one of the slide-out page and the slide-in page on the screen 120 in the direction of the gesture having the highest speed among the at least two gestures using the calculated average speed. The controller 110 determine a sliding-out speed of a slide-out page and a sliding-in speed of a slide-in page in response to the speed of the detected gesture, and perform sliding out and sliding in by applying visual effects to the slide-out page and the slide-in page being displayed, in response to the determined sliding-out speed and sliding-in speed, respectively.

The controller 110 may output at least one of sounds and vibrations corresponding to the visual effects. At least one of the sounds and vibrations may be the same as or different from each other in response to at least one of a gesture speed, a gesture direction, attributes of a slide-out page, attributes of a slide-in page, the number of sliding pages, and visual effects. The controller 110 may apply visual effects to at least one of the slide-out page and slide-in page being displayed. The visual effects may include at least one of shadow effects which are applied to at least one edge of the slide-out page, and 3D effects of the slide-out page. The controller 110 may apply the shadow effects to the edge that is last displayed on the screen 120, among the edges of the slide-out page. The shadow effects may include visual effects which are provided to allow the user to recognize the shadow that is naturally formed by light. At least one of a length and a width of the shadow may be adjusted by at least one of the direction of the gesture and the speed of the gesture.

The controller 110 may adjust the sliding-out speed of the slide-out page to be higher than the sliding-in speed of the slide-in page. On the contrary, the controller 110 may adjust the sliding-out speed of the slide-out page to be lower than the sliding-in speed of the slide-in page. At least one of the slide-out page and the slide-in page according to various embodiments of the present invention may be comprised of at least two layers. The controller 110 may adjust the sliding speed of each of the at least two layers to be different from each other in proportion to the measured speed, and display the layer in response to the input gesture. The controller 110 may differently adjust the sliding speed of each layer being displayed to be the same as each other, in proportion to the speed of the detected gesture, or adjust the sliding speed of each layer being displayed by different amounts. On the contrary, the controller 110 may adjust the sliding speed of each layer being displayed to be the same as each other, in proportion to the speed of the detected gesture, or adjust the sliding speed of each layer being displayed by the same amount. The controller 110 may cause the top layer among the at least two layers to have the highest sliding speed, and cause the lower layers to have lower sliding speeds. On the contrary, the controller 110 may cause the top layer among the at least two layers to have the lowest sliding speed, and cause the lower layers to have higher sliding speeds.

The controller 110 may apply at least one of shadow effects which are applied to at least one edge of the slide-out page, and 3D effects of the slide-out page. The controller 110 may provide visual effects that the user can recognize, to the slide-out page. The shadow effects may be applied differently depending on at least one of the measured speed of the gesture and the angle at which the slide-out page falls from the screen 120 as it slides. The controller 110 may apply the 3D effects to the slide-out page in the process where the slide-out page appears to disappear from the screen 120 as it slides. The 3D effects may include visual effects allowing the user to recognize that the slide-out page appears to move three-dimensionally. The controller 110 may apply, to the slide-out page, at least one of 3D effects that makes it appear that the slide-out page falls from the screen 120 as it slides, 3D effects that makes it appear that the slide-out page rises from the screen 120 as it slides, 3D effects that makes it appear that the slide-out page disappears from the screen 120 as it rotates, and 3D effects that makes it appear that the slide-out page gradually disappears from the screen 120 by a fading technique. At least one of these 3D effects may be effects that the user can recognize, and in addition to the 3D effects, the present invention may include a variety of visual effects allowing the user to recognize that the slide-out page appears to move three-dimensionally. The controller 110 may apply the 3D effects to the slide-out page depending on at least one of the measured speed of the gesture and the angle at which the slide-out page falls from the screen 120 as it slides.

The screen 120 receives at least one touch input through the user's body (e.g., fingers) or a touch input unit (e.g., a stylus pen, an electronic pen and the like). The screen 120 includes the hovering recognition device 121 for recognizing a hovering input made by a pen such as a stylus pen and an electronic pen, and the touch recognition device 122 for recognizing a touch input made by the user's body or the touch input unit. The hovering recognition device 121 detects a distance or gap between the pen and the screen 120 using a magnetic field, supersonic waves, optical information or surface acoustic waves, and the touch recognition device 122 detects a touched point using electrical charges that move due to the touch. The touch recognition device 122 may detect all types of touches which may cause static electricity, and may also detect a touch made by an input unit such as a finger and a pen.

The screen 120 may receive at least one gesture input made by at least one of at least one touch and hovering. Depending on the way it is input, the gesture includes at least one of a touch, a tap, a double tap, a flick, a drag, a drag & drop, a swipe, multi swipes, pinches, a touch & hold, a shake and a rotation. The term ‘touch’ refers to a gesture of contacting an input unit on the screen 120, the term ‘tap’ refers to a gesture of slightly tapping the screen 120 with the input unit, the term ‘double tap’ refers to a gesture of quickly tapping the screen 120 twice, the term ‘flick’ refers to a gesture (e.g., a scroll gesture) of contacting the input unit on the screen 120 and then releasing the input unit from the screen 120 after rapidly moving the input unit, the term ‘drag’ refers to a gesture of moving or scrolling an object displayed on the screen 120, the term ‘drag & drop’ refers to a gesture of moving an object on the screen 120 while touching the screen 120 and then releasing the input unit from the screen 120 after stopping the movement, the term ‘swipe’ refers to a gesture of moving the input unit by a predetermined distance while touching the screen 120 with the input unit, the term ‘multi swipes’ refers to a gesture of moving at least two input units (or fingers) by a predetermined distance while touching the screen 120 with the input units, the term ‘pinches’ refers to a gesture of moving at least two input units (or fingers) in different directions while touching the screen 120 with the input units, the term ‘touch & hold’ refers to a gesture of continuously inputting a touch or hovering to the screen 120 until an object, such as a Balloon Help icon, is displayed on the screen 120, the term ‘shake’ refers to a gesture of performing an operation by shaking the electronic device, and the term ‘rotate’ refers to a gesture of rotating the direction of the screen 120 from the vertical direction to the horizontal direction, or from the horizontal direction to the vertical direction.

The gestures of the present invention include not only the swipe gesture of moving a touch made on the screen 120 by a predetermined distance while maintaining the touch, and the flick gesture of making a touch on the screen 120 and then releasing the touch from the screen 120 after rapidly moving the touch, but also the hovering-based swipe gesture on the screen 120 and the hovering-based flick gesture on the screen 120. In the present invention, an operation may be performed using at least one of these gestures, and in addition to the aforementioned gestures, the present invention may include gestures made by at least one of various touches and hovering gestures that the electronic device can recognize.

The screen 120 provides an analog signal corresponding to the at least one gesture to the screen controller 130.

In various embodiments of the present invention, the touch is not limited to a direct touch (or contact touch) between the screen 120 and the user's body or the touch input unit, but also includes an indirect touch (or noncontact touch) between the screen 120 and the user's body or the touch input unit, with a detectable gap between them set to a predetermined value. The detectable gap between the screen 120 and the user's body or the touch input unit may be subject to change depending on the performance or structure of the electronic device 100. For example, the screen 120 may be configured to output different values (including, for example, analog voltage values or current values) detected by a touch event and a hovering event so as to make it possible to separately detect the touch event and the hovering event (or noncontact input) made by direct touch and indirect touch between the screen 120 and the user's body or the touch input unit. Further, the screen 120 may output the detected values (e.g., current values and the like) differently depending on the distance or gap between the screen 120 and the space where the hovering event occurs.

The hovering recognition device 121 or the touch recognition device 122 may be implemented in, for example, a resistive type, a capacitive type, an infrared type, or an acoustic wave type.

The screen 120 may include at least two touch screen panels capable of detecting the touch and proximity to the user's body and the touch input unit, respectively, so as to make it possible to receive the inputs made by the user's body and the touch input unit sequentially or simultaneously. The at least two touch screen panels may provide different output values to the screen controller 130, and the screen controller 130 may recognize the values received from the at least two touch screen panels different from each other, making it possible to determine whether an input from the screen 120 is an input by the user's body or an input by the touch input unit. The screen 120 may display at least one object or an input string.

More specifically, the screen 120 may be formed in a structure in which a touch panel for detecting an input made by a finger or an input unit that depend on a change in induced electromotive force, and a panel for detecting a touch on the screen 120 by the finger or the input unit, are sequentially stacked in close contact with each other, or are spaced apart from each other. The screen 120 may have a plurality of pixels, and may display images or handwritten information entered by the input unit or the finger, using the pixels. The screen 120 may use, as its panel, a Liquid Crystal Display (LCD) panel, an Organic Light Emitting Diodes (OLED) panel, an Light Emitting Diodes (LED) panel, or the like.

The screen 120 may have a plurality of sensors for detecting the position where a finger or an input unit is in contact with the surface of the screen 120, or the finger or the input unit is located over the screen 120 by a predetermined distance. Each of the plurality of sensors may be formed in a coil structure, and for a sensor layer formed of a plurality of sensors, each of the sensors may have a preset pattern, and form a plurality of electrode lines. Due to this structure, if a touch occurs on the screen 120 by the finger or the input unit, a detection signal, the waveform of which is changed due to a change in capacitance between the sensor layer and the input means, is generated in the touch recognition device 122. The screen 120 provides the generated detection signal to the controller 110. The distance or gap between the input unit and the hovering recognition device 121 may be determined depending on the strength of a magnetic field formed by the coil.

The screen controller 130 converts a received analog signal corresponding to a string entered on the screen 120 into a digital signal (e.g., X and Y coordinates), and provides the digital signal to the controller 110. The controller 110 controls the screen 120 using the digital signal received from the screen controller 130. For example, the controller 110 may select or execute a shortcut icon or an object displayed on the screen 120 in response to a touch event or a hovering event. The screen controller 130 may be incorporated into the controller 110.

The screen controller 130 may determine the distance between the screen 120 and the space where a hovering event occurs, by detecting the values (e.g., current values and the like) output from the screen 120, and may convert the determined distance value into a digital signal (e.g., Z coordinates) and provide the digital signal to the controller 110.

The communication unit 140 may include a mobile communication unit, a sub-communication unit, a Wireless Local Area Network (WLAN) unit, and a short-range communication unit, depending on its communication scheme, transmission distance, and the type of the data that is transmitted and received. The mobile communication unit, under control of the controller 110, connects the electronic device 100 to the external devices via at least one or multiple antennas through mobile communication. The mobile communication unit transmits and receives wireless signals for voice calls, video calls, Short Message Service (SMS) messages or Multimedia Messaging Service (MMS) messages, to/from a cellular phone, a smart phone, a tablet PC or other devices, a phone number of each of which is entered or registered in the electronic device 100.

The sub-communication unit includes at least one of the WLAN unit and the short-range communication unit. For example, the sub-communication unit may include either or both of the WLAN unit and the short-range communication unit. The sub-communication unit exchanges control signals with an input unit. A control signal exchanged between the electronic device 100 and the input unit may include at least one of a field for supplying power to the input unit, a field for detecting a touch or hovering between the input unit and the screen 120, a field for detecting an input made by pressing a button mounted on the input unit, and a field indicating the input unit's identifier, and the X/Y coordinates where the input unit is located. The input unit may transmit a feedback signal for the control signal received from the electronic device 100, to the electronic device 100.

The WLAN unit, under control of the controller 110, accesses the Internet in places where a wireless Access Point (AP) is installed. The WLAN unit supports the WLAN standard IEEE802.11x defined by the Institute of Electrical and Electronics Engineers (IEEE). The short-range communication unit, under control of the controller 110, enables wireless short-range communication between the electronic device 100 and an image forming apparatus. The short-range communication scheme may include Bluetooth, Infrared Data Association (IrDA), WiFi-Direct, Near Field Communication (NFC), and the like.

The controller 110 communicates with nearby communication devices or remote communication devices, receives a variety of data such as images, emoticons, photos and the like, over the Internet, and communicates with the input unit, through at least one of the sub-communication unit and the WLAN unit. This communication may be achieved by exchange of control signals.

The multimedia unit 150 includes a broadcasting and communication unit, an audio playback unit and a video playback unit. The broadcasting and communication unit, under control of the controller 110, receives broadcast signals (e.g., TV broadcast signals, radio broadcast signals, data broadcast signals or the like) and additional broadcast information (e.g., Electronic Program Guide (EPG), Electronic Service Guide (ESG) or the like) transmitted from broadcasting stations, via a broadcasting and communication antenna. The audio playback unit, under control of the controller 110, plays digital audio files (with a file extension of, for example, mp3, wma, ogg or way), which are stored in the storage 170 or received from the outside of the electronic device 100. The video playback unit, under control of the controller 110, plays digital video files (with a file extension of, for example, mpeg, mpg, mp4, avi, mov, or mkv), which are stored in the storage 170 or received from the outside of the electronic device 100. The video playback unit may play digital audio files.

The power supply 160, under control of the controller 110, supplies power to one or multiple rechargeable batteries which are mounted in the housing of the electronic device 100. The one or multiple rechargeable batteries supply power to the electronic device 100. The power supply 160 supplies, to the electronic device 100, the power that is received from an external power source via a wired cable connected to a connector. The power supply 160 supplies, to the electronic device 100, power that is wirelessly received from an external power source by wireless charging technology.

The storage 170, under control of the controller 110, stores signals or data, which are input and output to correspond to operations of the communication unit 140, the multimedia unit 150, the screen 120, and the I/O unit 180. The storage 170 may store a variety of applications and a control program for control of the electronic device 100 or the controller 110.

The storage 170 may include a non-volatile memory, a volatile memory, a Hard Disk Drive (HDD), or a Solid State Drive (SSD).

The storage 170 stores at least one of characters, words and strings, which are input to the screen 120, and also stores a variety of data such as texts, images, emoticons, icons and the like, that the user receives over the Internet. The storage 170 may store a variety of applications such as navigation applications, video call applications, game applications, time-based alarm applications and the like; images for providing Graphical User Interfaces (GUIs) associated with the applications; databases or data regarding how to handle user information, documents and touch input; background images (e.g., menu screens, standby screens and the like) or operational programs needed to drive the electronic device 100, and images captured by a camera unit. The storage 170 is machine (e.g., computer)-readable media, and the term ‘machine-readable media’ may be defined as media that provide data to a machine so that the machine may perform a specific function. The machine-readable media may be storage media. The storage 170 may include non-volatile media and volatile media. All types of the media should be configured such that commands carried by the media can be detected by a physical mechanism that reads the commands by the machine.

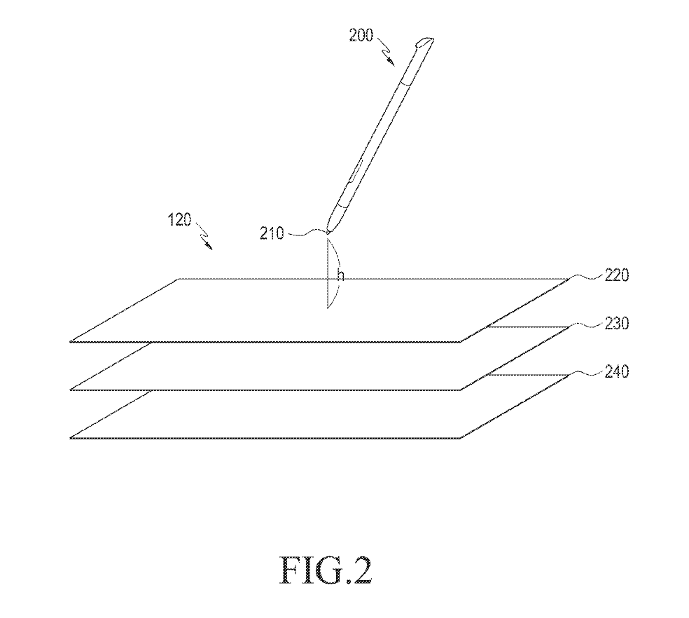

The I/O unit 180 includes at least one of a plurality of buttons, a microphone (MIC), a speaker (SPK), a vibration motor, a connector, a keypad, an earphone jack, and an input unit 200 (shown in FIG. 2). The I/O unit 180 is not limited thereto, and a cursor controller such as a mouse, a trackball, a joystick or cursor direction keys may be provided to control the movement of a cursor on the screen 120 through communication with the controller 110. The speaker in the I/O unit 180 outputs sounds corresponding to the control of at least one page displayed on the screen 120, and the vibration motor may also output vibrations corresponding to the control of at least one page displayed on the screen 120.

FIG. 2 illustrates an input unit and a cross-sectional view of a screen according to an embodiment of the present invention.

As illustrated in FIG. 2, the screen 120 according to an embodiment of the present invention includes at least one of a touch recognition panel 220, a display panel 230, and a hovering recognition panel 240. The display panel 230 may be a panel such as an LCD panel, an Active Matrix OLED (AMOLED) panel and the like, and displays various operating states of the electronic device 100, the operating results, a variety of images generated by execution of applications and services, and a plurality of objects.

The touch recognition panel 220, which is a capacitive touch panel, may be a panel coated with a dielectric, which is made by coating both sides of a glass with a thin metallic conductive material (e.g., an Indium Tin Oxide (ITO) film and the like) so that a current may flow on the surface of the glass, and which can store charges. If the user's finger or an input unit 200 touches the surface of the touch recognition panel 220, a predetermined amount of charges move to the touched point due to static electricity, and the touch recognition panel 220 recognizes a change in current due to the movement of charges, and detects the touched point. The touch recognition panel 220 detects at least one of a swipe gesture of moving a touch made on the touch recognition panel 220 by a predetermined distance while maintaining the touch, and a flick gesture of touching on the touch recognition panel 220 and then releasing the touch from the touch recognition panel 220 after rapidly moving the touch. The touch recognition panel 220 may detect all types of touches which may cause static electricity thorough the touch recognition panel 220.

The hovering recognition panel 240, which is an Electro-Magnetic Resonance (EMR) touch panel, includes an electromagnetic induction coil sensor having a grid structure in which a plurality of loop coils are arranged in a predetermined first direction and a second direction crossing the first direction, and an electronic signal processor that sequentially provides an Alternating Current (AC) signal having a predetermined frequency to each loop coil of the electromagnetic induction coil sensor. If the input unit 200, in which a resonance circuit is embedded, exists around a loop coil of the hovering recognition panel 240, a magnetic field transmitted from the loop coil causes a mutual electromagnetic induction-based current in the resonance circuit in the input unit 200. Based on the current, an induced magnetic field occurs from a coil constituting the resonance circuit in the input unit 200, and the hovering recognition panel 240 detects the induced magnetic field from the loop coil that has received a signal, making it possible to determine a hovering point and a touch point of the input unit 200, and enables the electronic device 100 to determine a height ‘h’ from the touch recognition panel 220 to a pen tip 210 of the input unit 200. It will be apparent to those of ordinary skill in the art that the height ‘h’ from the touch recognition panel 220 of the screen 120 to the pen tip 210 of the input unit 200 is subject to change depending on the performance or structure of the electronic device 100. Through the hovering recognition panel 240, the input unit 200 may detect both hovering and touch, if the input unit 200 can generate an electromagnetic induction-based current, and the hovering recognition panel 240 will be assumed to be exclusively used to detect hovering or touch made by the input unit 200. The input unit 200 may be referred to as an electronic pen or an EMR pen. The input unit 200 may be different from a normal pen that is detected through the touch recognition panel 220 and that does not include a resonance circuit. The input unit 200 may include a button that can change an electromagnetic induction value generated by a coil that is arranged within a pen holder in a region adjacent to the pen tip 210.

The screen controller 130 may include each of a touch recognition controller and a hovering recognition controller. The touch recognition controller converts an analog signal generated by detecting a touch input by the finger or the input unit 200 and received from the touch recognition panel 220, into a digital signal (e.g., X/Y/Z coordinates), and provides the digital signal to the controller 110. The hovering recognition controller converts an analog signal generated by detecting a hovering input by the finger or the input unit 200 and received from the hovering recognition panel 240, into a digital signal, and provides the digital signal to the controller 110. The controller 110 of the electronic device 100 controls the touch recognition panel 220, the display panel 230 and the hovering recognition panel 240 using the digital signals received from the touch recognition controller and the hovering recognition controller. For example, the controller 110 may display a predetermined type of screen on the display panel 230 in response to a hovering or touch input by the finger, the pen, the input unit 200 or the like.

Therefore, in the electronic device 100 according to an embodiment of the present invention, the touch recognition panel 220 detects a touch input by the user's finger and/or the pen, and the hovering recognition panel 240 detects a hovering input by the user's finger and/or the input unit 200. The structure of each of the panels can be changed in design. The controller 110 of the electronic device 100 may separately detect a touch or hovering input by the user's finger or the pen, and a touch or hovering input by the input unit 200. Although only a touch screen is illustrated in FIG. 2, the electronic device 100 according to an embodiment of the present invention is not limited to a single screen, and may include a plurality of screens, and each of the plurality of screens also detect at least one of a touch input and a hovering input as described above. Each of the screens may be mounted on each housing and connected to a hinge, or the plurality of screens may be mounted on a single housing. Each of the plurality of screens may be configured to include a display panel and at least one pen/touch recognition panel, as illustrated in FIG. 2.

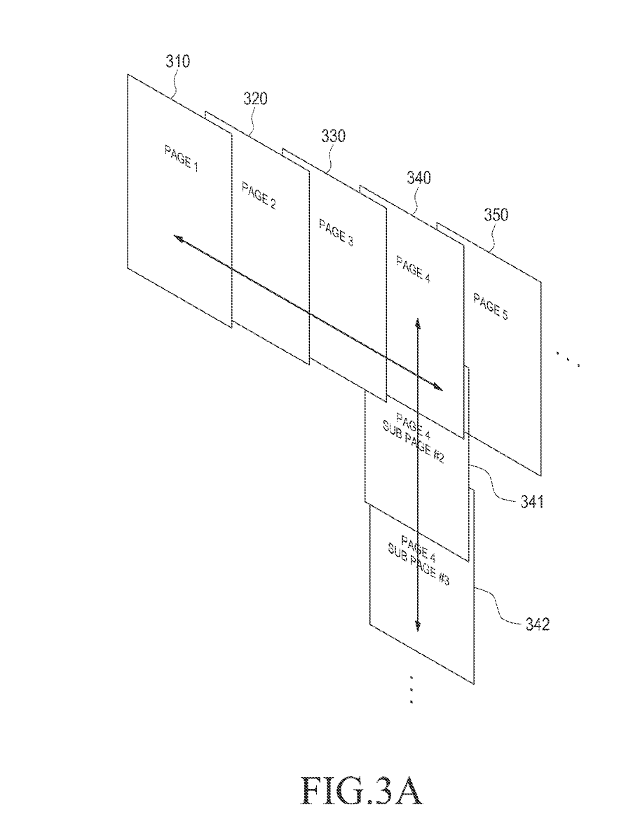

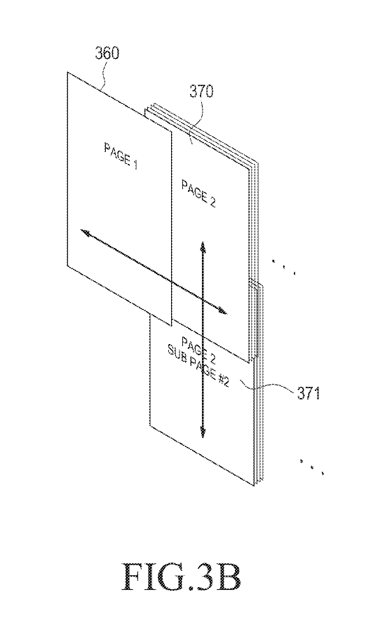

FIG. 3A illustrates the configuration of pages displayed on a screen of an electronic device according to an embodiment of the present invention, and FIG. 3B illustrates the configuration of pages displayed on a screen of an electronic device according to another embodiment of the present invention.

As illustrated in FIG. 3A, at least one page displayed on a screen of an electronic device according to an embodiment of the present invention undergoes at least one of sliding out and sliding in on the screen 120 in response to at least one gesture that is input to the screen 120. Each page may be classified according to the category, and each page may include at least one sub page. The pages may overlap each other. Referring to FIG. 3A, pages according to an embodiment of the present invention include at least a first page 310, a second page 320, a third page 330, a fourth page 340, and a fifth page 350. Although it is assumed in FIG. 3A that the first page 310 appears on the top, this is merely an example, and any one of the first to fifth pages may exist on the top in another embodiment of the present invention. Each of the pages 310 to 350 may be classified according to a category, and include at least one sub page. The sub pages may also be classified according to the content or data. For example, the fourth page 340 may be configured to include a second sub page 341 and a third sub page 342 according to the content, and the fourth page 340 may be a first sub page existing on the second sub page 341. Each page or each sub page may be comprised of at least one layer. Each of the pages 310 to 350 move or undergo sliding out or sliding in on the screen 120 in response to at least one gesture that is input to the screen 120. Sub pages (e.g., sub pages 341 and 342 of the fourth page 340) of pages classified by each category also move or undergo sliding out or sliding in on the screen 120 in any one of the up, down, left and right directions in response to at least one gesture. At least one page according to various embodiments of the present invention may undergo at least one of sliding out and sliding in not only in the up, down, left and right directions, but also in a direction (e.g., a diagonal direction) of the gesture. Each of the pages 310 to 350 according to an embodiment of the present invention may be called a category, since it can be classified by category. Sub pages (e.g., sub pages 341 and 342 of the fourth page 340) for each category may also be called a category, since they can be classified by category.

As illustrated in FIG. 3B, at least one page displayed on a screen of an electronic device according to another embodiment of the present undergoes at least one of sliding out and sliding in on the screen 120 in response to at least one gesture that is input to the screen 120. Each page may be classified according to the category, and each page may include at least one sub page. The pages may overlap each other. Referring to FIG. 3B, a plurality of pages according to another embodiment of the present invention may be configured in order of a first page 360 and a second page 370. Pages following the second page 370 may fully overlap each other under the second page 370. Each of the pages 360 and 370 may be classified according to a category, and include at least one sub page. The sub pages may also be classified according to the content or data. For example, the second page 370 may be configured to include a second sub page 371 according to the content, and the second page 370 may be a first sub page existing on the second sub page 371. Pages following the second sub page 371 may fully overlap each other under the second sub page 371. Each page or each sub page may be comprised of at least one layer. Each of the pages 360 and 370 move or undergo sliding out or sliding in on the screen 120 in response to at least one gesture that is input to the screen 120. Sub pages (e.g., the sub page 371 of the second page 370) of pages classified by each category also move or undergo sliding out or sliding in on the screen 120 in any one of the up, down, left and right directions in response to at least one gesture. At least one page according to various embodiments of the present invention may undergo at least one of sliding out and sliding in not only in the up, down, left and right directions, but also in a direction (e.g., a diagonal direction) of the gesture. Each of the pages 360 and 370 according to another embodiment of the present invention may be called a category, since it can be classified by category. Sub pages (e.g., the sub page 371 of the second page 370) for each category may also be called a category, since they can be classified by category. FIG. 3A illustrates that each of the pages do not overlap each other. FIG. 3B illustrates that pages following the second page 370 fully overlap each other under the second page 370.

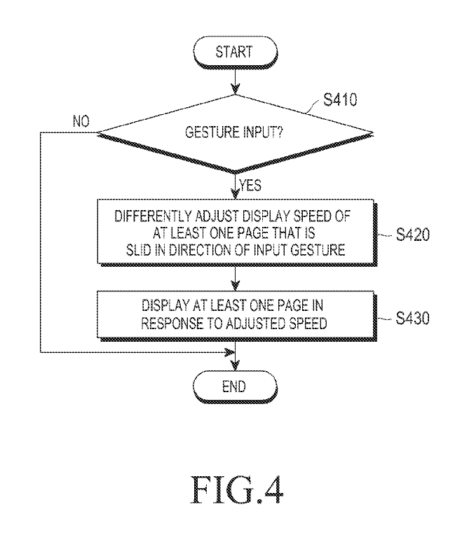

FIG. 4 is a flowchart illustrating a method for controlling a screen in an electronic device according to an embodiment of the present invention.

If a gesture is input in step S410, the controller 110 adjusts a display speed of at least one page that is slid in a direction of the input gesture to be different from other pages in step S420. The controller 110 detects at least one gesture that is input to the screen 120. The gesture may include at least one of a swipe, a flick, a hovering-based swipe, and a hovering-based flick on the screen 120, as well as other gestures that the controller 110 may detect on the screen 120. The controller 110 adjusts a sliding speed of at least one page that is displayed on the screen 120 as it slides in a direction of the detected gesture. As described above, the controller 110 may adjust the sliding speed of at least one page to be different from other pages. For example, the controller 110 may adjust a sliding speed of a slide-out page to be higher than, lower than, or to the same as a sliding speed of a slide-in page in response to the input gesture. Each page (or sub page) according to an embodiment of the present invention may be comprised of at least one layer, and for each layer, its sliding speed may be adjusted to be different from other layers in response to the input gesture by the controller 110. If any page comprised of at least two layers is moved or slid in response to an input gesture, the controller 110 may adjust the sliding speeds of the layers so that the top layer among the at least two layers may have the highest sliding speed, and the lower layers may have lower sliding speeds.

The screen 120, under control of the controller 110, displays at least one page (and/or subpage) at the adjusted speed in step S430. The controller 110 may provide visual effects to at least one of the slide-out page and slide-in page being displayed, in response to the input gesture. The visual effects may include at least one of shadow effects which are applied to at least one edge of the slide-out page and/or the slide-in page, and 3D effects of the slide-out page and/or slide-in page. In various embodiments of the present invention, in addition to these visual effects, there may be provided a variety of effects allowing the user to recognize that visual effects are provided to the page. The controller 110 may output sounds corresponding to the display of at least one page. The sounds may be the same as or different from each other in response to at least one of a gesture speed, a gesture direction, attributes of a slide-out page, attributes of a slide-in page, the number of sliding pages, and visual effects. Upon detecting at least one gesture input, the controller 110 may output sounds through the I/O unit 180 in response to at least one of a gesture speed, a gesture direction, attributes of a slide-out page, attributes of a slide-in page, the number of sliding pages, and visual effects.

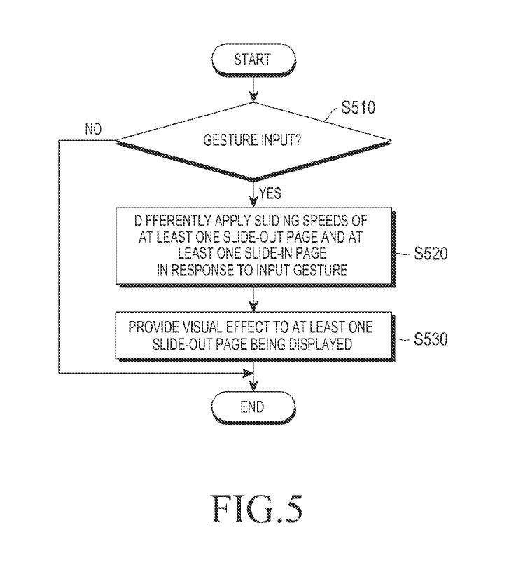

FIG. 5 is a flowchart illustrating a method for controlling a screen in an electronic device according to another embodiment of the present invention.

If a gesture is input in step S510, the controller 110 applies different sliding speeds for at least one slide-out page and at least one slide-in page in response to the input gesture in step S520. The controller 110 applies the sliding speed of the slide-out page to be higher than, lower than, or the same as the sliding speed of the slide-in page. The controller 110 measures the speed of the gesture that is detected on or input to the screen 120, and may compare the measured speed with a speed in a predetermined threshold range. If at least two gesture inputs are detected on the screen 120, the controller 110 may measure a speed of each of the gestures. The controller 110 may determine a gesture corresponding to the highest speed by measuring the speed of each of the gestures. The controller 110 may adjust the speed of each page so that at least one of the slide-out page and the slide-in page may be displayed on the screen 120, in response to at least one of the direction of the gesture and the highest speed.

If at least two gestures are detected, the controller 110 may calculate an average speed of speeds of the at least two gestures. The controller 110 may control the screen 120 to display at least one of the slide-out page and the slide-in page in a direction of a gesture having the highest speed among the at least two gestures, using the calculated average speed. The controller 110 may determine the sliding speed of the slide-out page or the sliding speed of the slide-in page in proportion to or in inverse proportion to the measured speed of the gesture. The controller 110 may determine the number of pages that are slid out or slid in, in response to the measured speed, or in response to the comparison results between the measured speed and the speed in the predetermined threshold range. The number of pages may be proportional, or inversely proportional to the measured speed of the gesture. Alternatively, the number of pages may be proportional, or inversely proportional to the speed corresponding to the comparison results between the measured speed and the speed in the predetermined threshold range. At least one of the slide-out page and the slide-in page according to another embodiment of the present invention may be comprised of at least two layers, and the controller 110 may apply the sliding speed of each layer to be different from each other in proportion to the speed of the detected gesture. The controller 110 may adjust the sliding speeds of the layers so that the top layer among the at least two layers may have the highest sliding speed, and the lower layers may have lower sliding speeds. On the contrary, the controller 110 may adjust the sliding speeds of the layers so that the top layer among the at least two layers may have the lowest sliding speed, and the lower layers may have higher sliding speeds.

The controller 110 applies visual effects to at least one slide-out page being displayed in step S530. The controller 110 provides visual effects to at least one slide-out page, and the screen 120, under control of the controller 110, may display the at least one slide-out page to which the visual effects are applied. The controller 110 according to another embodiment of the present invention may output sounds corresponding to the visual effects. The visual effects may include at least one of shadow effects which are applied to at least one edge of the slide-out page, and 3D effects of the slide-out page. The 3D effects may include at least one of 3D effects that makes it appear that the slide-out page falls from the screen 120 as it slides, 3D effects that makes it appear that the slide-out page rises from the screen 120 as it slides, and 3D effects that makes it appear that the slide-out page disappears from the screen 120 as it rotates. In various embodiments of the present invention, in addition to these visual effects, there may be provided a variety of effects allowing the user to recognize that visual effects are provided to the page.

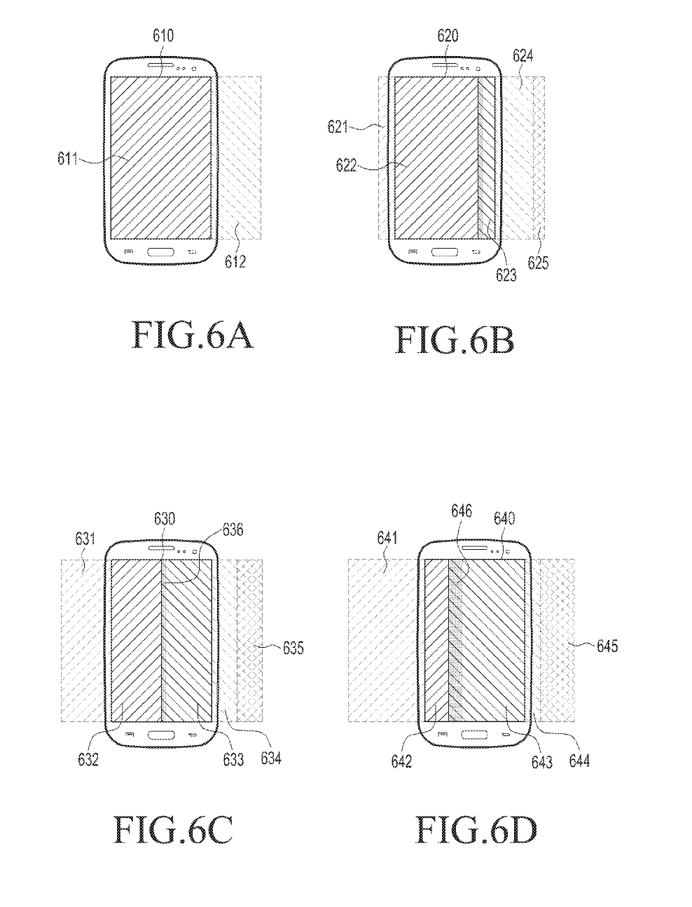

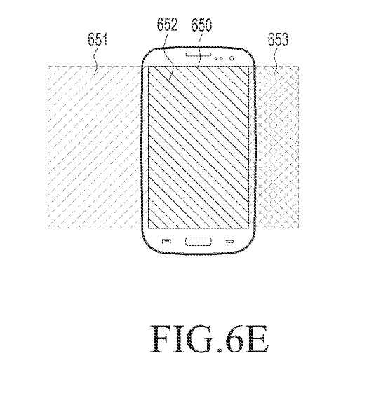

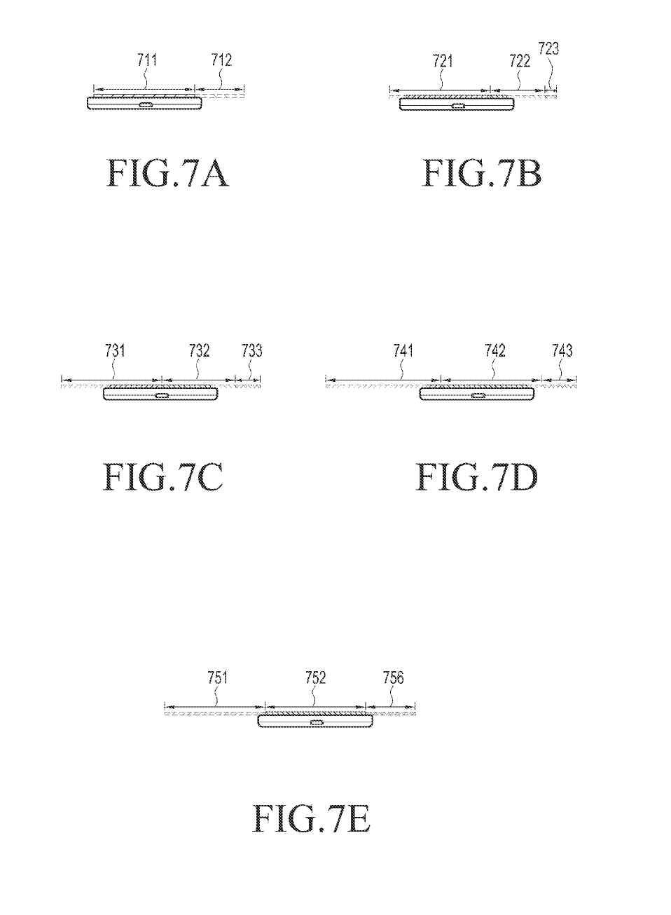

FIGS. 6A to 6E illustrate front views for a process in which at least one page is displayed on a screen in response to a gesture according to an embodiment of the present invention, and FIGS. 7A to 7E illustrate end views for a process in which at least one page is displayed on a screen in response to a gesture according to an embodiment of the present invention.

Specifically, FIG. 6A illustrates a front view of a screen before a gesture is input thereto according to an embodiment of the present invention, FIG. 6B illustrates a front view of a screen on which sliding of pages begins after the input of a gesture according to an embodiment of the present invention, FIG. 6C illustrates a front view of a screen on which sliding of pages is performed after the input of a gesture according to an embodiment of the present invention, FIG. 6D illustrates a front view of a screen on which sliding of pages is about to be completed after the input of a gesture according to an embodiment of the present invention, and FIG. 6E illustrates a front view of a screen on which sliding of pages is completed after the input of a gesture according to an embodiment of the present invention.

Specifically, FIG. 7A illustrates an end view of a screen before a gesture is input thereto according to an embodiment of the present invention, FIG. 7B illustrates an end view of a screen on which sliding of pages begins after the input of a gesture according to an embodiment of the present invention, FIG. 7C illustrates an end view of a screen on which sliding of pages is performed after the input of a gesture according to an embodiment of the present invention, FIG. 7D illustrates an end view of a screen on which sliding of pages is about to be completed after the input of a gesture according to an embodiment of the present invention, and FIG. 7E illustrates an end view of a screen on which sliding of pages is completed after the input of a gesture according to an embodiment of the present invention.

As illustrated in FIGS. 6A to 7E, at least one page that is displayed on a screen in response to a gesture according to an embodiment of the present invention is classified into at least one slide-out page that gradually disappears from the screen 120, and at least one slide-in page that is gradually displayed on the screen 120. Although it will be assumed in FIGS. 6A to 7E that an input gesture is a gesture (e.g., a flick or a swipe) that is input from the right to the left on the screen 120, the present invention may be applied when the input gesture is a gesture that is input from the left to the right on the screen 120.

Referring to FIG. 6A, a first page 611 is currently displayed on a screen 610, and a second page 612 is a page that can be slid in on the screen 610 in response to sliding out of the first page 611. Upon detecting an input of a gesture on the screen 610, the controller 110 determines a direction of the input gesture, and also measures a speed of the input gesture and determines the number of pages to be slid out, in response to the measured speed. If the direction of the gesture corresponds to a direction of a gesture that is input from the right to the left on the screen 610, the first page 611 is slid out, gradually disappearing from the screen 610, and the second page 612 is gradually displayed. The sliding speed may be proportional, or inversely proportional to the speed of the input gesture. Referring to FIG. 7A, a first page 711 is currently displayed on the screen 610, and a second page 712 is a page that can be slid in on the screen 610 in response to sliding out of the first page 711. Upon detecting an input of a gesture on the screen 610, the controller 110 determines a direction of the input gesture, and slides out the first page 711. If the direction of the gesture corresponds to a direction of a gesture that is input from the right to the left on the screen 610, the first page 711 is slid out to the left, gradually disappearing from the screen 610, and the second page 712 is gradually slid to the left and displayed. The sliding speed may be proportional, or inversely proportional to the speed of the input gesture.

Referring to FIG. 6B, a first region 621 of the first page (e.g., a page being slid out) is a region that has disappeared from a screen 620 in response to the input gesture, and a second region 622 of the first page is a region that has not yet disappeared from the screen 620, and is a region that will disappear over time. A first region 623 of the second page (e.g., a page being slid in) is a region that is displayed on the screen 620 in response to the input gesture, and a second region 624 of the second page is a region that has not yet been displayed on the screen 620, but is a region that can be displayed over time. Reference numeral 625 represents a partial region of a third page that will be displayed after the second page 612. A shadow or a shaded region that the user can recognize exists between the second region 622 of the first page and the first region 623 of the second page. Referring to FIG. 7B, for a first page 721 (e.g., a page being slid out), its partial region disappears from the screen 620 in response to the input gesture, and for a second page 722 (e.g., a page being slid in), its partial region is displayed on the screen 620 in response to the input gesture. Reference numeral 723 represents a partial region of a third page that will be displayed after the second page 722. As seen in FIG. 6B, the second region 622 of the first page may overlap the first region 623 of the second page.

Referring to FIG. 6C, it can be noted that the first region 631 of the first page in FIG. 6C is wider than the first region 621 of the first page in FIG. 6B, meaning that the first page 611 is being slid out from the right to the left. As in FIG. 6B, the first region 631 of the first page is a region that has disappeared from a screen 630 in response to the input gesture, and the second region 632 of the first page is a region that has not yet disappeared from the screen 630, and is a region that will disappear over time. The first region 633 of the second page is a region that is displayed on the screen 630 in response to the input gesture, and it can be noted that the first region 633 of the second page is wider than the first region 623 of the second page in FIG. 6B, meaning that the second page 612 is being slid in from the right to the left. The second region 634 of the second page is a region that has not yet been displayed on the screen 630, but is a region that will be displayed over time. Reference numeral 635 represents a partial region of the third page that is displayed after the second page 612. A shadow or a shaded region 636 that the user can recognize exists between the second region 632 of the first page and the first region 633 of the second page. For the shaded region, its size or width may be adjusted depending on various environments such as a speed of a gesture, an incident angle of light, and an angle at which the electronic device 100 is tilted. Referring to FIG. 7C, it can be noted that the slid-out region of the first page in FIG. 7C is greater than the slid-out region of the first page in FIG. 7B, meaning that a first page 731 is being slid out from the right to the left. In addition, it can be noted that the slid-in region of the second page in FIG. 7C is greater than the slid-in region of the second page in FIG. 7B, meaning that the second page 732 is being slid in from the right to the left. Reference numeral 733 represents a partial region of the third page that will be displayed after the second page 732. As seen in FIG. 6C, the second region 632 of the first page may overlap the first region 633 of the second page.

Referring to FIG. 6D, it can be noted that the first region 641 of the first page in FIG. 6D is wider than the first region 631 of the first page in FIG. 6C, meaning that the first page 611 is being slid out from the right to the left. As in FIG. 6C, the first region 641 of the first page is a region that has disappeared from a screen 640 in response to an input gesture, and the second region 642 of the first page is a region that has not yet disappeared from the screen 640, and is a region that will disappear over time. The first region 643 of the second page is a region that is displayed on the screen 640 in response to the input gesture, and it can be noted that the first region 643 of the second page is wider than the first region 633 of the second page in FIG. 6C, meaning that the second page 612 is being slid out from the right to the left. The second region 644 of the second page is a region that has not yet been displayed on the screen 640, but is a region that will be displayed over time. Reference numeral 645 represents a partial region of the third page that is displayed after the second page 612, and the region 645 is wider than the regions 625 and 635 in FIGS. 6B and 6C. The second region 642 of the first page may overlap the first region 643 of the second page. A shadow or a shaded region 646 that the user can recognize exists between the second region 642 of the first page and the first region 643 of the second page. The shaded region 646 in FIG. 6D may be wider than the shaded region 636 in FIG. 6C, because the sliding speed in FIG. 6D is higher than the sliding speed in FIG. 6C, or the sliding time in FIG. 6D is longer than the sliding time in FIG. 6C. For the shaded region, its size or width may be adjusted depending on various environments such as a speed of a gesture, an incident angle of light, and an angle at which the electronic device 100 is tilted. Referring to FIG. 7D, it can be noted that the slid-out region of the first page in FIG. 7D is greater than the slid-out region of the first page in FIG. 7C, meaning that the first page 741 is being slid out from the right to the left. In addition, it can be noted that the slid-in region of the second page in FIG. 7D is greater than the slid-in region of the second page in FIG. 7C, meaning that the second page 742 is being slid in from the right to the left. Reference numeral 743 represents a partial region of the third page that is displayed after the second page 742.

Referring to FIG. 6E, the first page 651 is fully slid out from a screen 650, and the second page 652 is fully slid in. A third page 653 may be displayed on the screen 650 after the second page 652. Referring to FIG. 7E, the first page 751 is fully slid out from the screen 650, and the second page 752 is fully slid in. A third page 756 may be displayed after the second page 752. In FIGS. 6A to 7E, the input gesture is a gesture (e.g., a flick or a swipe) that is input from the right to the left on the screen. However, the present invention may be applied when the input gesture is a gesture that is input from the left to the right on the screen. If the input gesture is an input from the left to the right on the screen, the controller 110 detects a gesture for displaying again the first page on the screen. Also, the controller 110 slides out the second page displayed on the screen from the screen in response to the detection of the gesture and slides in the first page to the screen in response to the sliding out of the second page, wherein the second page is displayed on the screen, covering a second region of the first page.

In FIGS. 6A to 7E, the regions which are out of the screen may be virtual regions used to easily describe the process in which at least one page is slid out or slid in according to the present invention.

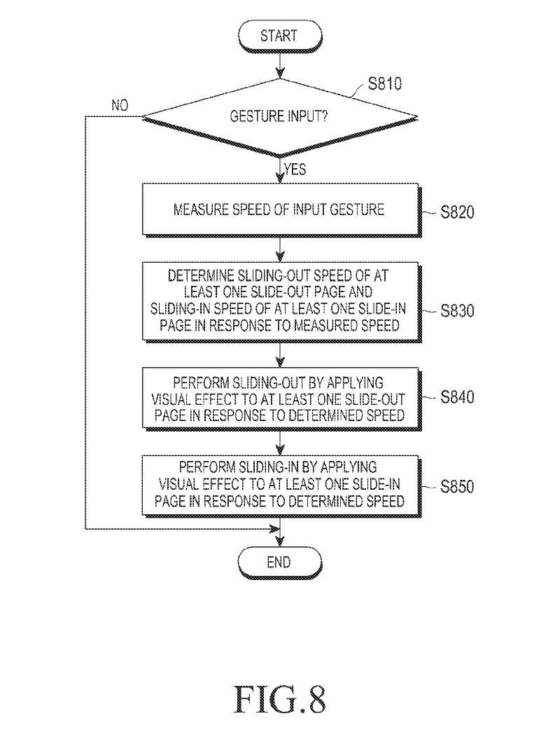

FIG. 8 is a flowchart illustrating a method for controlling a screen in an electronic device according to another embodiment of the present invention.

If a gesture is input in step S810, the controller 110 measures a speed of the input gesture in step S820. Upon detecting a gesture on the screen 120, the controller 110 measures at least one of a speed of the detected gesture and a direction of the gesture. The controller 110 compares the measured speed with a speed in a predetermined threshold range. If inputs of at least two gestures are detected on the screen 120, the controller 110 may measure a speed of each of the gestures. The controller 110 may determine a gesture corresponding to the highest speed by measuring the speed of each of the gestures, and display at least one of a slide-out page and a slide-in page on the screen 120 in response to at least one of the direction of the gesture and the highest speed. If at least two gestures are detected, the controller 110 may calculate an average speed of speeds of the at least two gestures, and display at least one of the slide-out page and the slide-in page on the screen 120 in the direction of the gesture having the highest speed among the at least two gestures using the calculated average speed.

The controller 110 determines a sliding-out speed of at least one slide-out page and a sliding-in speed of at least one slide-in page in response to the measured speed in step S830. The controller 110 may adjust the sliding-out speed of the slide-out page to be higher than the sliding-in speed of the slide-in page. On the contrary, the controller 110 may adjust the sliding-out speed of the slide-out page to be lower than the sliding-in speed of the slide-in page. The controller 110 may apply sliding speeds of at least two layers configured in each page to be different from each other. The controller 110 may adjust the sliding speeds of the layers so that the top layer among the at least two layers per page may have the highest sliding speed, and the lower layers may have lower sliding speeds. On the contrary, the controller 110 may adjust the sliding speeds of the layers so that the top layer among the at least two layers per page may have the lowest sliding speed, and the lower layers may have higher sliding speeds.

The controller 110 may perform sliding out and sliding in by applying visual effects to at least one slide-out page and at least one slide-in page in response to the determined speed, respectively, in steps S840 and S850. The slide-out page may be placed on the slide-in page, and the slide-in page may be displayed on the screen 120 as it slides at a ratio higher than a ratio at which the slide-out page is slid out from the screen 120. On the contrary, the slide-out page may be placed under the slide-in page, and the slide-in page may be displayed on the screen 120 as it slides at a ratio lower than a ratio at which the slide-out page is slid out from the screen 120. The visual effects include at least one of shadow effects which are applied to at least one edge of the slide-out page, and 3D effects of the slide-out page. The 3D effects include at least one of 3D effects that makes it appear that the slide-out page falls from the screen 120 as it slides, 3D effects that makes it appear that the slide-out page rises from the screen 120 as it slides, and 3D effects that makes it appear the slide-out page disappears from the screen 120 as it rotates. The shadow effects may be applied differently depending on at least one of the measured speed of the gesture and the angle at which the slide-out page falls from the screen 120 as it slides. The controller 110 provides the visual effects to at least one slide-out page, and the screen 120, under control of the controller 110, displays the at least one slide-out page to which the visual effects are applied. In various embodiments of the present invention, in addition to these visual effects, there may be provided a variety of effects allowing the user to recognize that visual effects are provided to the page. For example, the controller 110 may output sounds corresponding to the visual effects. The sounds may be the same as or different from each other in response to at least one of a gesture speed, a gesture direction, attributes of a slide-out page, attributes of a slide-in page, the number of sliding pages, and visual effects.

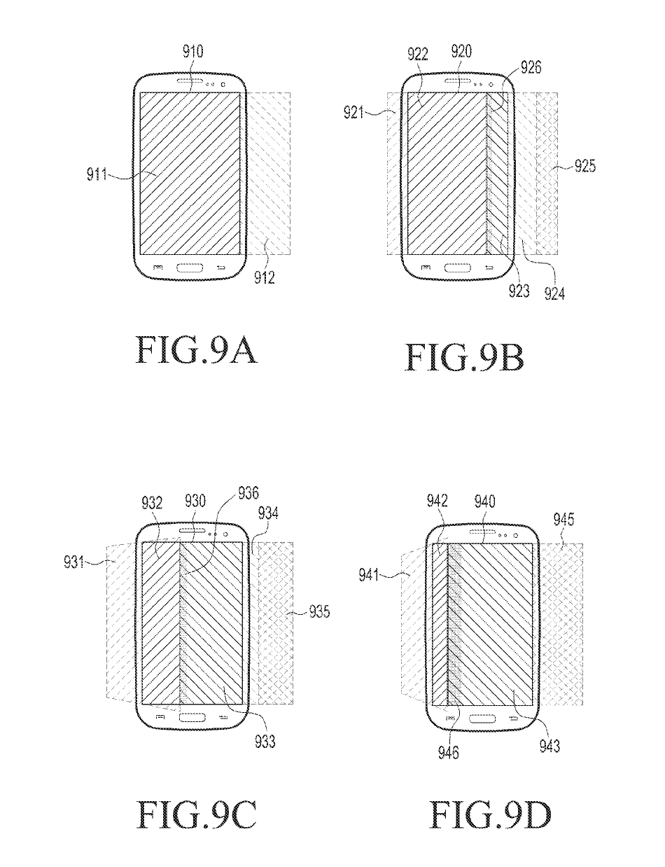

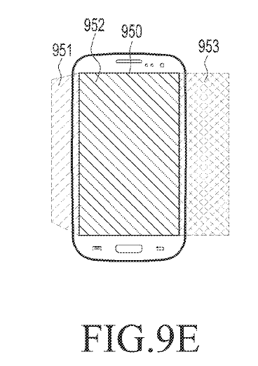

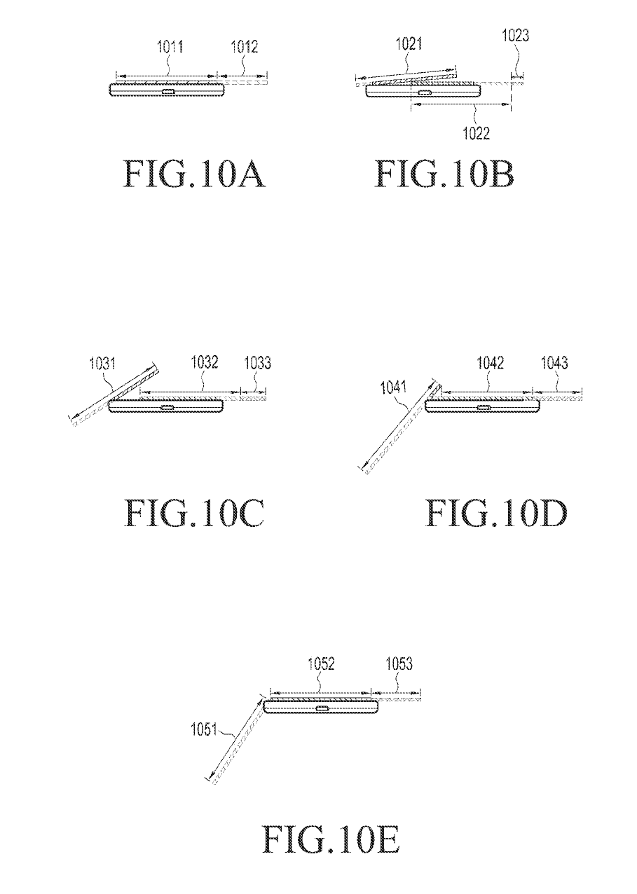

FIGS. 9A to 9E illustrate front views for a process in which at least one page is displayed on a screen in response to a gesture according to another embodiment of the present invention, and FIGS. 10A to 10E illustrate end views for a process in which at least one page is displayed on a screen in response to a gesture according to another embodiment of the present invention.

Specifically, FIG. 9A illustrates a front view of a screen before a gesture is input thereto according to another embodiment of the present invention, FIG. 9B illustrates a front view of a screen on which sliding of pages begins after the input of a gesture according to another embodiment of the present invention, FIG. 9C illustrates a front view of a screen on which sliding of pages is performed after the input of a gesture according to another embodiment of the present invention, FIG. 9D illustrates a front view of a screen on which sliding of pages is about to be completed after the input of a gesture according to another embodiment of the present invention, and FIG. 9E illustrates a front view of a screen on which sliding of pages is completed after the input of a gesture according to another embodiment of the present invention.

Specifically, FIG. 10A illustrates an end view of a screen before a gesture is input thereto according to another embodiment of the present invention, FIG. 10B illustrates an end view of a screen on which sliding of pages begins after the input of a gesture according to another embodiment of the present invention, FIG. 10C illustrates an end view of a screen on which sliding of pages is performed after the input of a gesture according to another embodiment of the present invention, FIG. 10D illustrates an end view of a screen on which sliding of pages is about to be completed after the input of a gesture according to another embodiment of the present invention, and FIG. 10E illustrates an end view of a screen on which sliding of pages is completed after the input of a gesture according to another embodiment of the present invention.

As illustrated in FIGS. 9A to 9E and FIGS. 10A to 10E, at least one page displayed on a screen in response to a gesture according to another embodiment of the present invention is classified into at least one slide-out page that gradually disappears from the screen 120, and at least one slide-in page that is gradually displayed on the screen 120. Although it will be assumed in FIGS. 9A to 10E that an input gesture is a gesture (e.g., a flick or a swipe) that is input from the right to the left on the screen 120, the present invention may be applied when the input gesture is a gesture that is input from the left to the right on the screen 120.

Referring to FIG. 9A, a first page 911 is currently displayed on a screen 910, and a second page 912 is a page that can be slid in on the screen 910 in response to sliding out of the first page 911. Upon detecting an input of a gesture on the screen 910, the controller 110 determines a direction of the input gesture, and also measures a speed of the input gesture and determines the number of pages to be slid out, in response to the measured speed. If the direction of the gesture corresponds to a direction of a gesture that is input from the right to the left on the screen 910, the first page 911 is slid out, gradually disappearing from the screen 910, and the second page 912 is gradually displayed. The sliding speed may be proportional, or inversely proportional to the speed of the input gesture. The first page 911 may be slid out so as to appear to be gradually falling or dropping. Referring to FIG. 10A, a first page 1011 is currently displayed on the screen 910, and a second page 1012 is a page that can be slid in on the screen 910 in response to sliding out of the first page 1011. Upon detecting an input of a gesture on the screen 910, the controller 110 determines a direction of the input gesture, and slides out the first page 1011. If the direction of the gesture corresponds to a direction of a gesture that is input from the right to the left on the screen 910, the first page 1011 is slid out to the left, gradually disappearing from the screen 910, and the second page 1012 is gradually slid to the left and displayed. The sliding speed may be proportional, or inversely proportional to the speed of the input gesture. The first page 1011 may be slid out so as to appear to be gradually falling or dropping.

Referring to FIG. 9B, a first region 921 of the first page (e.g., a page being slid out) is a region that has disappeared from a screen 920 in response to the input gesture, and a second region 922 of the first page is a region that has not yet disappeared from the screen 920, and is a region that will disappear using the effects that the region gradually drops over the time. A first region 923 of the second page (e.g., a page being slid in) is a region that is displayed on the screen 920 in response to the input gesture, and a second region 924 of the second page is a region that has not yet been displayed on the screen 920, but is a region that will be displayed over time. Reference numeral 925 represents a partial region of a third page that is displayed after the second page 912. A shadow or a shaded region 926 that the user can recognize exists between the second region 922 of the first page and the first region 923 of the second page. For the shadow or the shaded region, its size or width may be adjusted depending on an angle at which the first page 911 drops, or an incident angle of light. Referring to FIG. 10B, for a first page 1021 (e.g., a page being slid out), its partial region disappears from the screen 920 in response to the input gesture, and for a second page 1022 (e.g., a page being slid in), its partial region is displayed on the screen 920 in response to the input gesture. Reference numeral 1023 represents a partial region of a third page that is displayed after the second page 1022. A partial region of the first page may overlap a partial region of the second page. The first page 1021 may provide visual effects that the page falls at a preset angle, or at various angles depending on the speed of the gesture.

Referring to FIG. 9C, it can be noted that the first region 931 of the first page in FIG. 9C is wider than the first region 921 of the first page in FIG. 9B, or the first region 931 of the first page in FIG. 9C is greater than the first region 921 of the first page in FIG. 9B in terms of the falling angle, meaning that the first page 911 is being slid from the right to the left and is falling at a greater angle. As in FIG. 9B, the first region 931 of the first page is a region that has disappeared from a screen 930 in response to the input gesture, and a second region 932 of the first page is a region that has not yet disappeared from the screen 930, and is a region that will disappear over time. A first region 933 of the second page is a region that is displayed on the screen 930 in response to the input gesture, and it can be noted that the first region 933 of the second page is wider than the first region 923 of the second page in FIG. 9B, meaning that the second page 912 is being slid from the right to the left. A second region 934 of the second page is a region that has not yet been displayed on the screen 930, but is a region that will be displayed over time. Reference numeral 935 represents a partial region of the third page that is displayed after the second page 912. A shadow or a shaded region 936 that the user can recognize exists between the second region 932 of the first page and the first region 933 of the second page. The shaded region 936 in FIG. 9C is wider than the shaded region 926 in FIG. 9B, because the second page in FIG. 9C is greater than the second page in FIG. 9B in terms of at least one of the sliding speed and the sliding time. For the shaded region, its size or width may be adjusted depending on various environments such as an angle at which a page falls, a speed of a gesture, an incident angle of light, and an angle at which the electronic device 100 is tilted.

Referring to FIG. 10C, it can be noted that the slid-out region of the first page in FIG. 10C is greater than the slid-out region of the first page in FIG. 10B, meaning that a first page 1031 is being slid from the right to the left. In addition, it can be noted that a tilt angle of the first page in FIG. 10C is greater than a tilt angle of the first page in FIG. 10B, meaning that the first page 1031 is dropping by being slid from the right to the left. Further, it can be noted that the slid-in region of the second page in FIG. 10C is greater than the slid-in region of the second page in FIG. 10B, meaning that the second page 1032 is being slid from the right to the left. Reference numeral 1033 represents a partial region of the third page that is displayed after the second page 1032. A partial region of the first page may overlap a partial region of the second page. The first page 1031 provides visual effects that the page falls at a preset angle, or at various angles depending on the speed of the gesture.

Referring to FIG. 9D, it can be noted that a first region 941 of the first page in FIG. 9D is wider than the first region 931 of the first page in FIG. 9C, or the first region 941 of the first page in FIG. 9D is greater than the first region 931 of the first page in FIG. 9C in terms of the extent of falling or dropping, meaning that the first page 911 is being slid from the right to the left. As in FIG. 9C, the first region 941 of the first page is a region that has disappeared from a screen 940 in response to an input gesture, and a second region 942 of the first page is a region that has not yet disappeared from the screen 940, and is a region that will disappear or fall over time. A first region 943 of the second page is a region that is displayed on the screen 940 in response to the input gesture, and it can be noted that the first region 943 of the second page is wider than the first region 933 of the second page in FIG. 9C, meaning that the second page 912 is being slid from the right to the left. A second region 944 of the second page is a region that has not yet been displayed on the screen 940, but is a region that will be displayed over time. Reference numeral 945 represents a partial region of the third page that is displayed after the second page 912, and the region 945 is wider than the regions 925 and 935 in FIGS. 9B and 9C. The second region 942 of the first page may overlap the first region 943 of the second page. A shadow or a shaded region 946 that the user can recognize exists between the second region 942 of the first page and the first region 943 of the second page, because the second page in FIG. 9D is greater than the second page in FIG. 9C in terms of at least one of the sliding speed and the sliding time. For the shaded region, its size or width may be adjusted depending on various environments such as a speed of a gesture, an incident angle of light, and an angle at which the electronic device 100 is tilted.

Referring to FIG. 10D, it can be noted that the slid-out region of the first page in FIG. 10D is greater than the slid-out region of the first page in FIG. 10C, meaning that the first page 1041 is dropping by being slid from the right to the left. In addition, it can be noted that the slid-in region of the second page in FIG. 10D is greater than the slid-in region of the second page in FIG. 10C, meaning that the second page 1042 is being slid from the right to the left. Reference numeral 1043 represents a partial region of the third page that may be displayed after the second page 1042.

Referring to FIG. 9E, a first page 951 has dropped by being fully slid out from a screen 950, and a second page 952 is fully slid in. A third page 953 is displayed on the screen 950 after the second page 952. Referring to FIG. 10E, a first page 1051 has dropped by being fully slid out from the screen 950, and a second page 1052 is fully slid in. A third page 1053 is displayed after the second page 1052. In FIGS. 9A to 10E, the input gesture is a gesture (e.g., a flick or a swipe) that is input from the right to the left on the screen. However, the present invention may be applied when the input gesture is a gesture that is input from the left to the right on the screen. If the input gesture is an input from the left to the right on the screen, the controller 110 detects a gesture for displaying again the first page on the screen. Also, the controller 110 slides out the second page displayed on the screen from the screen in response to the detection of the gesture and slides in the first page to the screen in response to the sliding out of the second page, wherein the second page is displayed on the screen, covering a second region of the first page.

In FIGS. 9A to 10E, the regions which are out of the screen may be virtual regions used to easily describe the process in which a slide-out page drops by being slid out and a slide-in page is slid in, according to the present invention.

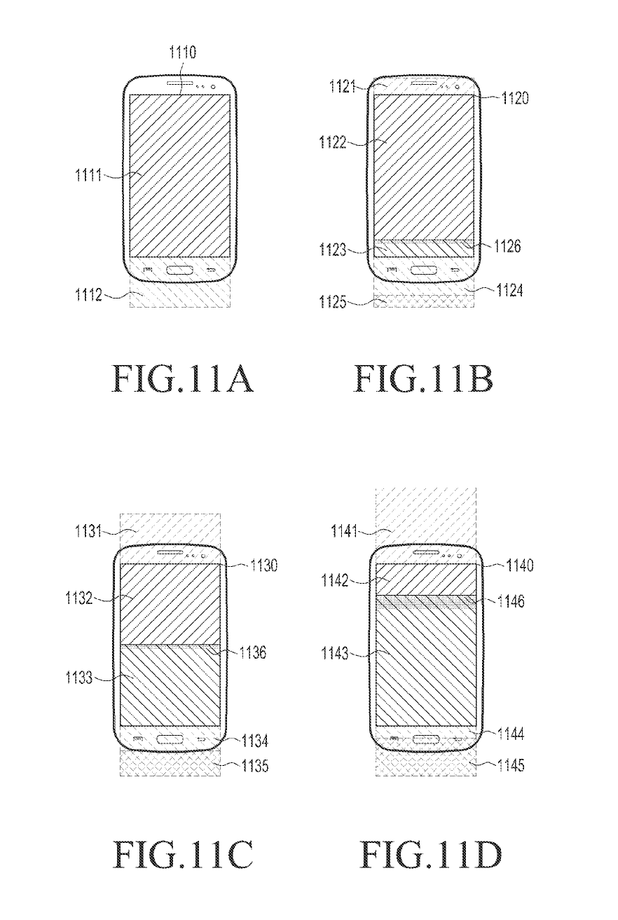

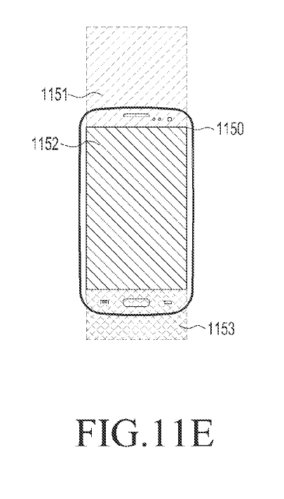

FIGS. 11A to 11E illustrate front views for a process in which at least one page is displayed on a screen in response to a gesture according to another embodiment of the present invention.

Specifically, FIG. 11A illustrates a front view of a screen before a gesture is input thereto according to another embodiment of the present invention, FIG. 11B illustrates a front view of a screen on which sliding of pages begins after the input of a gesture according to another embodiment of the present invention, FIG. 11C illustrates a front view of a screen on which sliding of pages is performed after the input of a gesture according to another embodiment of the present invention, FIG. 11D illustrates a front view of a screen on which sliding of pages is about to be completed after the input of a gesture according to another embodiment of the present invention, and FIG. 11E illustrates a front view of a screen on which sliding of pages is completed after the input of a gesture according to another embodiment of the present invention.

As illustrated in FIGS. 11A to 11E, at least one page displayed on a screen in response to a gesture according to another embodiment of the present invention is classified into at least one slide-out page that gradually disappears from the screen 120, and at least one slide-in page that is gradually displayed on the screen 120. Although it will be assumed in FIGS. 11A to 11E that an input gesture is a gesture (e.g., a flick or a swipe) that is input from the bottom to the top on the screen 120, the present invention may be applied when the input gesture is a gesture that is input from the top to the bottom on the screen 120.

Referring to FIG. 11A, a first page 1111 is currently displayed on a screen 1110, and a second page 1112 is a page that is slid in on the screen 1110 in response to sliding out of the first page 1111. Upon detecting an input of a gesture on the screen 1110, the controller 110 determines a direction of the input gesture, and also measures a speed of the input gesture and determines the number of pages to be slid out, in response to the measured speed. If the direction of the input gesture corresponds to a direction of a gesture that is input from the bottom to the top on the screen 1110, the first page 1111 is slid out, gradually disappearing from the screen 1110, and the second page 1112 is gradually displayed. A sliding speed thereof may be proportional, or inversely proportional to the speed of the input gesture.

Referring to FIG. 11B, a first region 1121 of the first page (e.g., a page being slid out) is a region that has disappeared from a screen 1120 in response to the input gesture, and a second region 1122 of the first page is a region that has not yet disappeared from the screen 1120, and is a region that will disappear over time. A first region 1123 of the second page (e.g., a page being slid in) is a region that is displayed on the screen 1120 in response to the input gesture, and a second region 1124 of the second page is a region that has not yet been displayed on the screen 1120, but is a region that will be displayed over time. Reference numeral 1125 represents a partial region of a third page that is displayed after the second page 1112. A shadow or a shaded region 1126 that the user can recognize exists between the second region 1122 of the first page and the first region 1123 of the second page. The shadow or the shaded region 1126 is interposed between the second region 1122 of the first page and the first region 1123 of the second page.

Referring to FIG. 11C, it can be noted that a first region 1131 of the first page in FIG. 11C is wider than the first region 1121 of the first page in FIG. 11B, meaning that the first page 1111 is being slid from the bottom to the top. As in FIG. 11B, the first region 1131 of the first page is a region that has disappeared from a screen 1130 in response to the input gesture, and a second region 1132 of the first page is a region that has not yet disappeared from the screen 1130, and is a region that will disappear over time. A first region 1133 of the second page is a region that is displayed on the screen 1130 in response to the input gesture, and it can be noted that the first region 1133 of the second page is wider than the first region 1123 of the second page in FIG. 11B, meaning that the second page 1112 is being slid from the bottom to the top. A second region 1134 of the second page is a region that has not yet been displayed on the screen 1130, but is a region that can be displayed over time. Reference numeral 1135 represents a partial region of the third page that is displayed after the second page 1112. A shadow or a shaded region 1136 that the user can recognize exists between the second region 1132 of the first page and the first region 1133 of the second page, because the second page in FIG. 11C is greater than the second page in FIG. 11B in terms of at least one of the sliding speed and the sliding time. For the shaded region, its size or width may be adjusted depending on various environments such as a speed of a gesture, an incident angle of light, and an angle at which the electronic device 100 is tilted.

Referring to FIG. 11D, it can be noted that a first region 1141 of the first page in FIG. 11D is wider than the first region 1131 of the first page in FIG. 11C, meaning that the first page 1111 is being slid from the bottom to the top. As in FIG. 11C, the first region 1141 of the first page is a region that has disappeared from a screen 1140 in response to an input gesture, and a second region 1142 of the first page is a region that has not yet disappeared from the screen 1140, and is a region that will disappear over time. A first region 1143 of the second page is a region that is displayed on the screen 1140 in response to the input gesture, and it can be noted that the first region 1143 of the second page is wider than the first region 1133 of the second page in FIG. 11C, meaning that the second page 1112 is being slid from the bottom to the top. A second region 1144 of the second page is a region that has not yet been displayed on the screen 1140, but is a region that may be displayed over time. Reference numeral 1145 represents a partial region of the third page that is displayed after the second page 1112, and the region 1145 is wider than the regions 1125 and 1135 in FIGS. 11B and 11C. The second region 1142 of the first page may overlap the first region 1143 of the second page. A shadow or a shaded region 1146 that the user can recognize exists between the second region 1142 of the first page and the first region 1143 of the second page, because the second page in FIG. 11D is greater than the second page in FIG. 11C in terms of at least one of the sliding speed and the sliding time. For the shaded region, its size or width may be adjusted depending on various environments such as a speed of a gesture, an incident angle of light, and an angle at which the electronic device 100 is tilted.

Referring to FIG. 11E, a first page 1151 is fully slid out from a screen 1150, and a second page 1152 is fully slid in. A third page 1153 may be displayed on the screen 1150 after the second page 1152. In FIGS. 11A to 11E, the input gesture is a gesture (e.g., a flick or a swipe) that is input from the bottom to the top on the screen. However, the present invention may be applied when the input gesture is a gesture that is input from the top to the bottom on the screen. If the input gesture is an input from the top to the bottom on the screen, the controller 110 detects a gesture for displaying again the first page on the screen. Also, the controller 110 slides out the second page displayed on the screen from the screen in response to the detection of the gesture and slides in the first page to the screen in response to the sliding out of the second page, wherein the second page is displayed on the screen, covering a second region of the first page.

In FIGS. 11A to 11E, the regions which are out of the screen may be virtual regions used to easily describe the process in which at least one page is slid out or slid in according to the present invention.

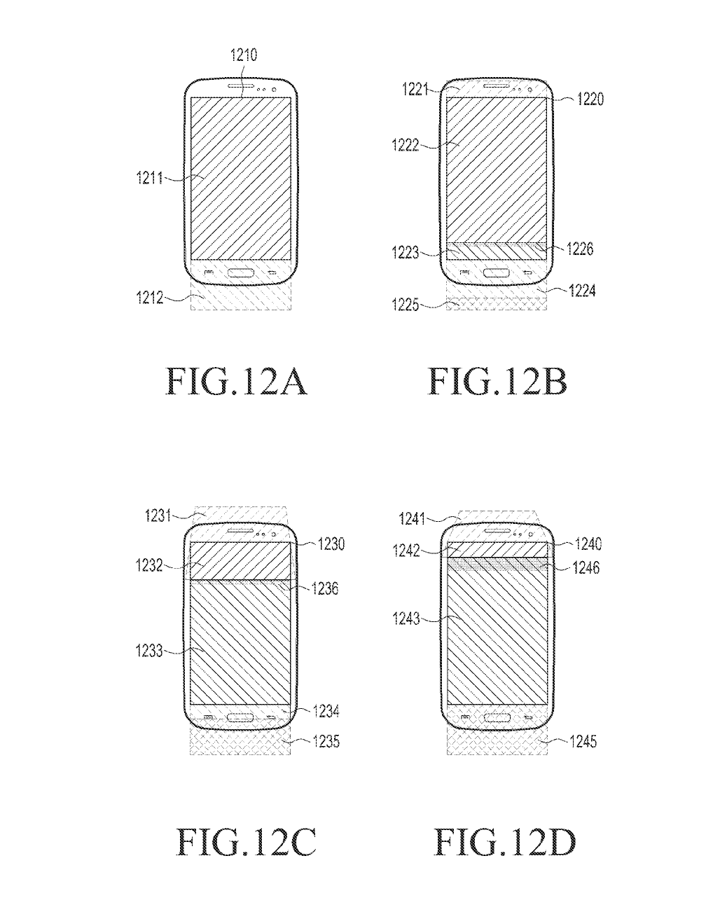

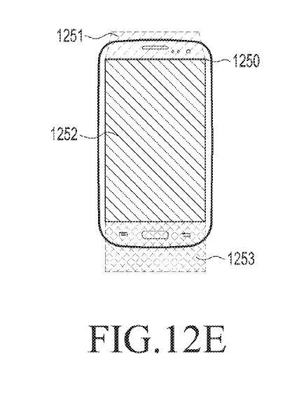

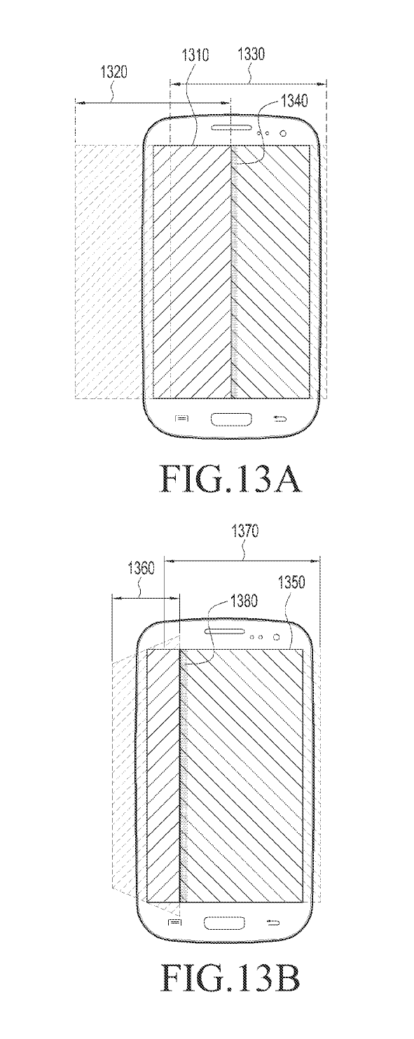

FIGS. 12A to 12E illustrate front views for a process in which at least one page is displayed on a screen in response to a gesture according to another embodiment of the present invention.

Specifically, FIG. 12A illustrates a front view of a screen before a gesture is input thereto according to another embodiment of the present invention, FIG. 12B illustrates a front view of a screen on which sliding of pages begins after the input of a gesture according to another embodiment of the present invention, FIG. 12C illustrates a front view of a screen on which sliding of pages is performed after the input of a gesture according to another embodiment of the present invention, FIG. 12D illustrates a front view of a screen on which sliding of pages is about to be completed after the input of a gesture according to another embodiment of the present invention, and FIG. 12E illustrates a front view of a screen on which sliding of pages is completed after the input of a gesture according to another embodiment of the present invention.

As illustrated in FIGS. 12A to 12E, at least one page displayed on a screen in response to a gesture according to another embodiment of the present invention is classified into at least one slide-out page that gradually disappears from the screen 120, and at least one slide-in page that is gradually displayed on the screen 120. Although it will be assumed in FIGS. 12A to 12E that an input gesture is a gesture (e.g., a flick or a swipe) that is input from the bottom to the top on the screen 120, the present invention may be applied when the input gesture is a gesture that is input from the top to the bottom on the screen 120.

Referring to FIG. 12A, a first page 1211 is currently displayed on a screen 1210, and a second page 1212 is a page that can be slid in on the screen 1210 in response to sliding out of the first page 1211. Upon detecting an input of a gesture on the screen 1210, the controller 110 determines a direction of the input gesture, and also measures a speed of the input gesture and determines the number of pages to be slid out, in response to the measured speed. If the direction of the input gesture corresponds to a direction of a gesture that is input from the bottom to the top on the screen 1210, the first page 1211 is slid out, gradually disappearing from the screen 1210, and the second page 1212 is gradually displayed. A sliding speed thereof may be proportional, or inversely proportional to the speed of the input gesture. The first page 1211 is slid out so as to appear to be gradually falling or dropping.

Referring to FIG. 12B, a first region 1221 of the first page (e.g., a page being slid out) is a region that has disappeared from a screen 1220 in response to the input gesture, and a second region 1222 of the first page is a region that has not yet disappeared from the screen 1220, and is a region that will disappear using the effects that the region gradually drops over time. A first region 1223 of the second page (e.g., a page being slid in) is a region that is displayed on the screen 1220 in response to the input gesture, and a second region 1224 of the second page is a region that has not yet been displayed on the screen 1220, but is a region that will be displayed over time. Reference numeral 1225 represents a partial region of a third page that is displayed after the second page 1212. A shadow or a shaded region 1226 that the user can recognize exists between the second region 1222 of the first page and the first region 1223 of the second page. For the shadow or the shaded region, its size or width may be adjusted depending on the angle at which the first page 1211 drops, or the incident angle of light.

Referring to FIG. 12C, it can be noted that a first region 1231 of the first page in FIG. 12C is wider than the first region 1221 of the first page in FIG. 12B, or the first region 1231 of the first page in FIG. 12C is greater than the first region 1221 of the first page in FIG. 12B in terms of the falling angle, meaning that the first page 1211 is being slid from the bottom to the top and is falling at a larger angle. As in FIG. 12B, the first region 1231 of the first page is a region that has disappeared from a screen 1230 in response to the input gesture, and a second region 1232 of the first page is a region that has not yet disappeared from the screen 1230, and is a region that will disappear over time. A first region 1233 of the second page is a region that is displayed on the screen 1230 in response to the input gesture, and it can be noted that the first region 1233 of the second page is wider than the first region 1223 of the second page in FIG. 12B, meaning that the second page 1212 is being slid from the bottom to the top. A second region 1234 of the second page is a region that has not yet been displayed on the screen 1230, but is a region that will be displayed over time. Reference numeral 1235 represents a partial region of the third page that is displayed after the second page 1212. A shadow or a shaded region 1236 that the user can recognize exists between the second region 1232 of the first page and the first region 1233 of the second page, because the second page in FIG. 12C is greater than the second page in FIG. 12B in terms of at least one of the sliding speed and the sliding time. For the shaded region, its size or width may be adjusted depending on various environments such as an angle at which a page falls, a speed of a gesture, an incident angle of light, and an angle at which the electronic device 100 is tilted.

Referring to FIG. 12D, it can be noted that a first region 1241 of the first page in FIG. 12D is wider than the first region 1231 of the first page in FIG. 12C, or the first region 1241 of the first page in FIG. 12D is greater than the first region 1231 of the first page in FIG. 12C in terms of the extent of dropping, meaning that the first page 1211 is falling by being slid from the bottom to the top. As in FIG. 12C, the first region 1241 of the first page is a region that has disappeared from a screen 1240 in response to an input gesture, and a second region 1242 of the first page is a region that has not yet disappeared from the screen 1240, and is a region that will disappear over time. A first region 1243 of the second page is a region that is displayed on the screen 1240 in response to the input gesture, and it can be noted that the first region 1243 of the second page is wider than the first region 1233 of the second page in FIG. 12C, meaning that the second page 1212 is being slid from the bottom to the top. Reference numeral 1245 represents a partial region of the third page that is displayed after the second page 1212, and the region 1245 is wider than the regions 1225 and 1235 in FIGS. 12B and 12C. The second region 1242 of the first page may overlap the first region 1243 of the second page. A shadow or a shaded region 1246 that the user can recognize exists between the second region 1242 of the first page and the first region 1243 of the second page, because the second page in FIG. 12D is greater than the second page in FIG. 12C in terms of at least one of the sliding speed and the sliding time. For the shaded region, its size or width may be adjusted depending on various environments such as a speed of a gesture, an incident angle of light, and an angle at which the electronic device 100 is tilted.

Referring to FIG. 12E, a first page 1251 has dropped by being fully slid out from a screen 1250, and a second page 1252 is fully slid in. A third page 1253 may be displayed on the screen 1250 after the second page 1252. In FIGS. 12A to 12E, the input gesture is a gesture (e.g., a flick or a swipe) that is input from the bottom to the top on the screen. However, the present invention may be applied when the input gesture is a gesture that is input from the top to the bottom on the screen. If the input gesture is an input from the top to the bottom on the screen, the controller 110 detects a gesture for displaying again the first page on the screen. Also, the controller 110 slides out the second page displayed on the screen from the screen in response to the detection of the gesture and slides in the first page to the screen in response to the sliding out of the second page, wherein the second page is displayed on the screen, covering a second region of the first page.

In FIGS. 12A to 12E, the regions which are out of the screen may be virtual regions used to easily describe the process in which a slide-out page drops by being slid out and a slide-in page is slid in, according to the present invention.

FIGS. 13A and 13B illustrate a screen on which a page is slid out in response to an input of a gesture according to different embodiments of the present invention.

Specifically, FIG. 13A illustrates a screen on which a page is slid out in response to an input of a gesture according to an embodiment of the present invention, and FIG. 13B illustrates a screen on which a page drops by being slid out in response to an input of a gesture according to another embodiment of the present invention.

Referring to FIG. 13A, a first page 1320 is slid out on a screen 1310 from the right to the left in response to an input gesture, gradually disappearing from the screen 1310. A second page 1330 is slid in on the screen 1310 from the right to the left in response to the input gesture, being gradually displayed on the screen 1310. The first page 1320 and the second page 1330 may overlap each other, and if the first page 1320 fully disappears from the screen 1310, the overlapping region no longer exists. A shadow or a shaded region 1340 exists between the first page 1320 and the second page 1330. For the shaded region 1340, its size or width may be adjusted depending on at least one of a speed of a gesture, an incident angle of light, and an angle at which the electronic device 100 is tilted. If the first page 1320 is fully slid out from the screen 1310, disappearing from the screen 1310, the shaded region 1340 also disappears from the screen 1310.

Referring to FIG. 13B, a first page 1360 is slid out on a screen 1350 from the right to the left in response to an input gesture, gradually falling from the screen 1350. A second page 1370 is slid in on the screen 1350 from the right to the left in response to the input gesture, being gradually displayed on the screen 1350. The first page 1360 and the second page 1370 may overlap each other, and if the first page 1360 fully disappears from the screen 1350, the overlapping region no longer exists. An angle at which the first page 1360 falls from the screen 1350 may gradually increase, while the first page 1360 is being slid out from the screen 1350. A shadow or a shaded region 1380 exists between the first page 1360 and the second page 1370. For the shaded region 1380, its size or width may be adjusted depending on at least one of a speed of a gesture, an incident angle of light, and an angle at which the electronic device 100 is tilted. If the first page 1360 is fully slid out from the screen 1350, falling from the screen 1350, the shaded region 1380 also disappears from the screen 1350.

Such visual effects may include at least one of shadow effects which are applied to at least one edge of the slide-out page, and 3D effects of the slide-out page. The 3D effects may include not only the 3D effects (e.g., FIG. 13A) that the slide-out page is slid out from the screen 120 and the 3D effects (e.g., FIG. 13B) that the slide-out page appears to fall from the screen 120 as it slides, but also at least one of 3D effects that the slide-out page appears to rise from the screen 120 as it slides and 3D effects that the slide-out page disappears from the screen 120 as it rotates. In addition, the 3D effects may include at least one of 3D effects that the slide-out page appears to rise from the screen 120 in the middle of appearing to fall from the screen 120 as it slides, 3D effects that the slide-out page appears to fall from the screen 120 in the middle of appearing to rise from the screen 120 as it slides, 3D effects that the slide-out page disappears from the screen 120 as it rotates, and 3D effects that the slide-out page gradually disappears from the screen 120 by a fading technique. At least one of these 3D effects may be the effects that the user can recognize, and in addition to the aforesaid 3D effects, the present invention may include a variety of visual effects allowing the user to recognize that the slide-out page appears to move three-dimensionally. The 3D effects may be applied differently depending on at least one of the measured speed of the gesture and the angle at which the slide-out page falls from the screen 120 as it slides.

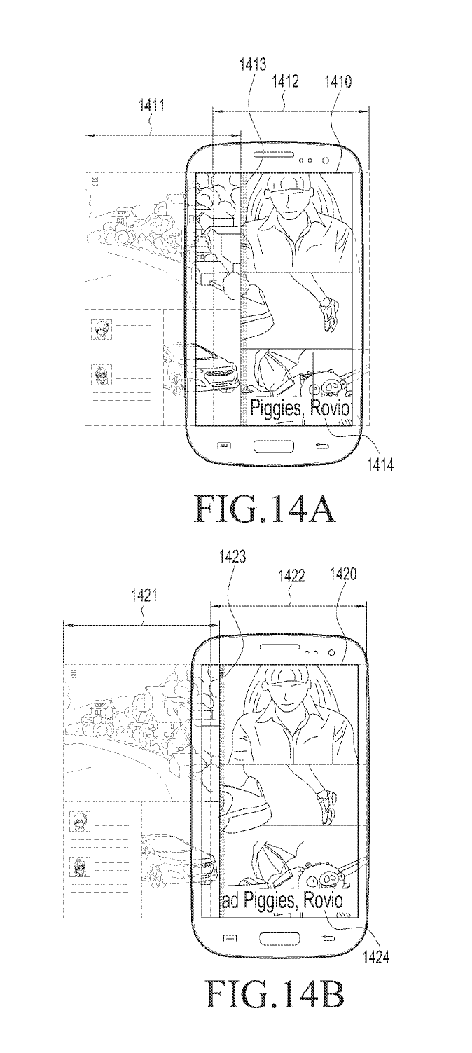

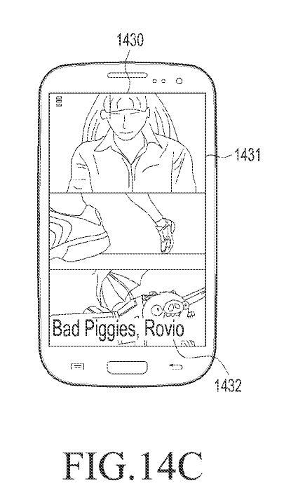

FIGS. 14A to 14C illustrate a process in which a page comprised of at least two layers is slid in on a screen in response to a gesture according to an embodiment of the present invention.

Specifically, FIG. 14A illustrates a screen on which an upper page is slid out in response to a gesture according to an embodiment of the present invention, FIG. 14B illustrates a screen on which a lower page is slid in, in response to a gesture according to an embodiment of the present invention, and FIG. 14C illustrates a screen on which at least two layers constituting a lower page are slid in at different speeds in response to a gesture according to an embodiment of the present invention.

Referring to FIG. 14A, if a gesture is made on a screen 1410 from the right to the left, a first page 1411 is slid out on the screen 1410 from the right to the left, gradually disappearing from the screen 1410. As soon as the first page 1411 is slid out, a second page 1412 is slid in on the screen 1410, being gradually displayed on the screen 1410. While the first page 1411 is slid out, a shadow or a shaded region 1413 may be displayed on the screen 1410. A ratio of the region where the second page 1412 is displayed on the screen 1410 may be greater than a ratio of the region where the first page 1411 has disappeared from the screen 1410 by being slid out. For example, if a gesture is input, sliding out of the first page 1411 begins. Since the second page 1412 exists under the first page 1411, the second page 1412 may not be displayed on the screen 1410 at the speed or ratio at which the first page 1411 is slid out. Instead, a region corresponding to the higher speed or higher ratio may be displayed on the screen 1410. At least one of the first page 1411 and the second page 1412 may be comprised of at least two layers. Each layer may be distinguished according to attributes of content such as images, texts and the like. The second page 1412 may include a text layer 1414 that includes texts. The text layer 1414 may be displayed on the screen 1410 at the same speed as, or a speed different from the speed at which the second page 1412 is displayed on the screen 1410. For example, if the text layer 1414 comprised of texts (e.g., Bad Piggies, Rovio) exists in the second page 1412, the text layer 1414 may be slid in at a speed different from that of the second page 1412. Some texts (e.g., Bad) on the text layer 1414 may be covered by the first page 1411.

Referring to FIG. 14B, a first page 1421 has almost disappeared from a screen 1420 by being slid out on the screen 1420 from the right to the left. As soon as the first page 1421 is almost slid out, a second page 1422 is fully slid in on the screen 1420. While the first page 1421 is slid out, a shadow or a shaded region 1423 is displayed on the screen 1420. As illustrated in FIGS. 14A and 14B, it can be noted that a text layer 1424 of the second page 1422 in FIG. 14B is shifted to the left, compared with the text layer 1414 of the second page 1412 in FIG. 14A, because the text layer 1424 of the second page 1422 is slid in at a different speed from that of the second page 1422. Some texts (e.g., B) on the text layer 1424 may be covered by the first page 1421.

Referring to FIG. 14C, in response to the input of a gesture, the first page 1421 in FIG. 14B is fully slid out from a screen 1430, disappearing from the screen 1430, and the second page 1422 is fully displayed on the screen 1430. When being slid out, the first page 1421 is slid out in any one of the methods of FIG. 13A and FIG. 13B. The first page 1421 may disappear using at least one of 3D effects that the page falls from the screen 1420 as it slides, 3D effects that the page appears to rise from the screen 1420 as it slides, and 3D effects that the page disappears from the screen 1420 as it rotates. At least one of these 3D effects may be the effects that the user can recognize, and in addition to the aforesaid 3D effects, the present invention may include a variety of visual effects allowing the user to recognize that the slide-out page appears to move three-dimensionally. A text layer 1432 configured on a second page 1431 may be slid in at a speed different from that of the second page 1431.

It can be appreciated that embodiments of the present invention may be implemented in the form of hardware, software or a combination thereof. The software may be stored in volatile or non-volatile storage (e.g., erasable/re-writable ROM and the like), memory (e.g., RAM, memory chip, memory device, memory Integrated Circuit (IC) and the like), or optically or magnetically recordable machine (e.g., computer)-readable storage media (e.g., Compact Disk (CD), Digital Versatile Disk (DVD), magnetic disk, magnetic tape and the like). Storage that can be mounted in an electronic device may be an example of the machine-readable storage media suitable to store a program or programs including instructions for implementing embodiments of the present invention. Therefore, the present invention includes a program including codes for implementing the apparatus and method defined by the appended claims, and machine-readable storage media storing the program. The program may be electronically carried by any media such as communication signals which are transmitted through wired/wireless connections.

The electronic device may receive and store the program from a program server to which the electronic device is connected by wires or wirelessly. The program server may include a memory for storing a program including instructions for implementing the screen control method, and storing information needed for the screen control method, a communication unit for performing wired/wireless communication with the electronic device, and a controller for transmitting the program to the electronic device automatically or at the request of the electronic device.

As is apparent from the foregoing description, according to various embodiments of the present invention, an electronic device may control a display speed of a page displayed on a screen, control sliding speeds of a slide-out page and a slide-in page, and provide visual effects, thereby improving the user's convenience.

In addition, according to an embodiment of the present invention, an electronic device may detect a gesture that is input to a screen, adjust a sliding speed of at least one page that is displayed on the screen as it slides in a direction of the detected gesture, and display the at least one page at the adjusted speed, thereby allowing the user to feel satisfaction in displaying pages in response to an input of the gesture.

Further, according to another embodiment of the present invention, an electronic device may detect a gesture that is input to a screen, apply different sliding speeds of a slide-out page and a slide-in page in response to the input gesture, and provide visual effects to the slide-out page being displayed, in response to sliding of the slide-out page, thereby displaying at least one page in a 3D manner, for the user.

Moreover, according to another embodiment of the present invention, an electronic device may measure a speed of a gesture that is input to a screen, determine a sliding-out speed of a slide-out page and a sliding-in speed of a slide-in page in response to the measured speed, and perform sliding out and sliding in by applying visual effects to the slide-out page and the slide-in page in response to the determined speeds, thereby displaying at least one of the slide-out page and the slide-in page in a 3D way depending on at least one of the direction and speed of the gesture that is input by the user.

While the present invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for controlling a screen in an electronic device, the method comprising:
displaying a first page on a screen;
detecting a gesture that is input to the screen;
sliding out the first page displayed on the screen from the screen in response to the detection of the gesture; and
sliding in a second page to the screen in response to the sliding out of the first page,
wherein in displaying the first page on the screen, the first page is displayed on the screen, covering a first region of the second page.

2. The method of claim 1, wherein sliding in the second page to the screen in response to sliding out the first page comprises displaying the first region of the second page, which was covered by the first page, on the screen as it slides, and displaying a second region of the second page except for the first region thereof as it slides in.

3. The method of claim 2, further comprising:
upon detecting a gesture for displaying again the first page on the screen, sliding out the second page displayed on the screen from the screen in response to the detection of the gesture and sliding in the first page to the screen in response to the sliding out of the second page,
wherein the second page is displayed on the screen, covering a second region of the first page.

4. The method of claim 3, wherein the sliding in of the first page to the screen in response to the sliding out of the second page comprises:
displaying the second region of the first page, which was covered by the second page, as it slides, and displaying a first region of the first page except for the second region thereof as it slides in.

5. The method of claim 1, further comprising:
applying different sliding speeds for a slide-out page and a slide-in page in response to the input gesture; and
providing a visual effect to the slide-out page being displayed, in response to sliding of the slide-out page.

6. The method of claim 5, wherein applying different sliding speeds comprises determining the sliding speed of the slide-out page to be higher than the sliding speed of the slide-in page.

7. The method of claim 5, wherein applying different sliding speeds comprises:
measuring a speed of the detected gesture; and
comparing the measured speed with a speed in a predetermined threshold range.

8. The method of claim 7, wherein applying different sliding speeds comprises:
determining the sliding speed of the slide-out page in proportion to the measured speed.

9. The method of claim 7, wherein applying different sliding speeds comprises:
determining the number of pages which are slid out on the screen, in response to the comparison results.

10. The method of claim 5, wherein at least one of the slide-out page and the slide-in page is comprised of at least two layers, and each layer is displayed such that a sliding speed thereof is applied differently in proportion to the speed of the detected gesture.

11. The method of claim 10, wherein a top layer among the at least two layers has a highest sliding speed, and a lower layer has a lower sliding speed.

12. The method of claim 5, further comprising outputting a sound corresponding to the visual effect.

13. The method of claim 5, wherein the visual effect includes at least one of a shadow effect that is applied to at least one edge of the slide-out page, and a Three-Dimensional (3D) effect of the slide-out page.

14. The method of claim 13, wherein the 3D effect includes at least one of a 3D effect that the slide-out page falls from the screen as it slides, a 3D effect that the slide-out page appears to rise from the screen as it slides, and a 3D effect that the slide-out page disappears from the screen as it rotates.

15. The method of claim 10, wherein a top layer among the at least two layers has a lowest sliding speed, and a lower layer has a higher sliding speed.

16. The method of claim 5, wherein the slide-in page is displayed on the screen as it slides at a ratio higher than a ratio at which the slide-out page is slid out from the screen.

17. The method of claim 5, wherein the slide-out page and the slide-in page are classified by category, and
wherein each of the slide-out page and the slide-in page includes at least one page.

18. The method of claim 13, wherein the shadow effect is applied differently depending on at least one of a measured speed of the gesture, and an angle at which the slide-out page falls from the screen as it slides.

19. The method of claim 1, wherein the gesture is input by at least one of a touch and hovering on the screen.

20. An electronic device for controlling a screen, the electronic device comprising:
a screen configured to display a first page; and
a controller configured to slide out the first page displayed on the screen from the screen in response to a gesture that is input to the screen, and to slide in a second page to the screen in response to the sliding out of the first page,
wherein the first page is displayed on the screen, covering a first region of the second page.

21. The electronic device of claim 20, wherein the controller is configured to display the first region of the second page, which was covered by the first page, on the screen as it slides, and to display a second region of the second page except for the first region thereof in a sliding-in way.

22. The electronic device of claim 21, wherein the controller is configured to, upon detecting a gesture for displaying again the first page on the screen, slide out the second page displayed on the screen from the screen in response to the detection of the gesture, and slide in the first page to the screen in response to the sliding out of the second page;
wherein the second page is displayed on the screen, covering a second region of the first page.

23. The electronic device of claim 22, wherein the controller is configured to display the second region of the first page, which was covered by the second page, as it slides, and to display a first region of the first page except for the second region thereof as it slides in.

24. The electronic device of claim 20, wherein the controller is configured to adjust a sliding speed of at least one page that is displayed on the screen as it slides in response to a direction of the gesture, and to display the at least one page in response to the adjusted speed.

25. The electronic device of claim 24, wherein the controller is configured to differently adjust the sliding speed of the at least one page to be different speeds.

26. The electronic device of claim 24, wherein the controller is configured to apply a visual effect to the at least one page being displayed.

27. The electronic device of claim 26, wherein the controller is configured to output a sound corresponding to the visual effect through an Input/Output (I/O) unit.

28. The electronic device of claim 24, wherein the controller is configured to measure a speed of the detected gesture, and compare the measured speed with a speed in a predetermined threshold range to adjust the sliding speed of the at least one page.

29. The electronic device of claim 28, wherein the controller is configured to determine a sliding-out speed of a slide-out page and a sliding-in speed of a slide-in page in response to the measured speed of the detected gesture, and to perform sliding out and sliding in by applying a visual effect to the slide-out page and the slide-in page in response to the determined speed thereof.

30. The electronic device of claim 29, wherein the controller is configured to apply, to the slide-out page, at least one of a shadow effect that is applied to at least one edge of the slide-out page, and a Three-Dimensional (3D) effect of the slide-out page.

31. The electronic device of claim 30, wherein the controller is configured to apply, to the slide-out page, at least one of a 3D effect that the slide-out page falls from the screen as it slides, a 3D effect that the slide-out page appears to rise from the screen as it slides, and a 3D effect that the slide-out page disappears from the screen as it rotates.
